(19) United States
(12) Patent Application Publication
(10) Pub. No.: US 2025/0001592 A1
(43) Pub. Date: Jan. 2, 2025

(54) Last-Mile Delivery Systems Incorporating Modular Robots

(71) Applicant: The Regents of the University of California, Oakland, CA (US)

(72) Inventors: Dennis Hong, Santa Monica, CA (US); Taoyuanmin Zhu, Los Angeles, CA (US); Gabriel Ikaika Fernandez, Honolulu, HI (US)

(73) Assignee: The Regents of the University of California, Oakland, CA (US)

(21) Appl. No.: 18/761,149

(22) Filed: Jul. 1, 2024

Related U.S. Application Data
(60) Provisional application No. 63/511,550, filed on Jun. 30, 2023.

(51) Int. Cl. B25J 9/16; B25J 15/00; B62D 57/032

(52) U.S. Cl. CPC B25J 9/1617; B25J 15/0033; B62D 57/032

(57) ABSTRACT

Arm-like robots and systems and methods that can move objects using multiple cooperating robots in accordance with various embodiments of the invention are described. In one embodiment, the arm-like robot includes a body having two ends, where the body comprises a plurality of actuated joints. In addition, the arm-like robot can include end-effectors attached at each end of the body, where each of the end-effectors is capable of both anchoring the arm-like robot to form a base and connecting to an object. The arm-like robot can also include at least one controller configured to control motion of the plurality of actuated joints and end-effectors so that one of the end-effectors can anchor the arm-like robot and form a base and the other end-effector can connect to a target object.

### CROSS-REFERENCE TO RELATED APPLICATIONS

The current application claims the benefit of and priority under 35 U.S.C. § 119(e) to U.S. Provisional Patent Application No. 63/511,550 entitled “Last-Mile Delivery Systems Incorporating Modular Robots” filed Jun. 30, 2023. The disclosure of U.S. Provisional Patent Application No. 63/511,550 is hereby incorporated by reference in its entirety for all purposes.

### FIELD OF THE INVENTION

The present invention generally relates to the field of robotics and, more specifically, to modular robots.

### BACKGROUND

The last mile of a package delivery tends to be the most difficult due to dynamic, uncertain environments both inside and outside a delivery vehicle. A delivery vehicle can start completely organized and packed with boxes. As packages are delivered, the neat stacks can slide or fall over as the vehicle moves. Outside of the vehicle, urban terrain can vary based on both location and building type.

Robots are now used in a variety of applications. Many robots are capable of performing complex actions, which can be grasping, manipulating, and/or moving objects. In some instances, robots are mobile and can move independently, which may be achieved by flying, walking and/or rolling on wheels.

A delivery robot is a robot that delivers packages. Some delivery robots are wheeled robots, such as the Starship robot by Starship Technologies OU. Wheeled robots are typically constrained to a single plane and flat terrain. Other delivery robots are unmanned aerial robots, such as the Amazon Prime Air drone by Amazon Technologies Inc. Aerial robots typically operate in all three dimensions, but are limited by operational and safety regulations.

The motion capabilities of robots are typically defined by the number of degrees of freedom a robot has. A degree-of-freedom may be a number of directions in which independent motion can occur. A more specific definition related to robots could be the number of joints or axes of motion that a robot or an appendage of a robot (e.g. a manipulator) is capable of employing.

### SUMMARY OF THE INVENTION

Systems and methods in accordance with various embodiments of the invention utilize modular robotic systems to perform last-mile delivery. In one embodiment, the arm-like robot includes a body having two ends, where the body comprises a plurality of actuated joints. In addition, the arm-like robot can include end-effectors attached at each end of the body, where each of the end-effectors is capable of both anchoring the arm-like robot to form a base and connecting to an object. The arm-like robot can also include at least one controller configured to control motion of the plurality of actuated joints and end-effectors so that one of the end-effectors can anchor the arm-like robot and form a base and the other end-effector can connect to a target object in order to move it.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which form a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 conceptually illustrates an arm-like robot that has six degrees of freedom configured in a symmetric fashion in accordance with an embodiment of the invention.

FIG. 2 photographs an arm-like robot that has six degrees of freedom and six joints configured in a symmetric fashion in accordance with an embodiment of the invention.

FIG. 3 conceptually illustrates a last-mile delivery scenario incorporating modular robotics in accordance with an embodiment of the invention.

FIG. 4A conceptually illustrates an arm-like robot that has seven degrees of freedom and seven joints configured in a symmetric fashion in an extended pose for tasks that require a large range of motion in accordance with an embodiment of the invention.

FIG. 4B conceptually illustrates an arm-like robot that has seven degrees of freedom and seven joints configured in a symmetric fashion in a wheeled motion pose with two wheels mounted side by side for self-balancing and movement in accordance with an embodiment of the invention.

FIG. 5 conceptually illustrates the range of motion of an arm-like robot that has six degrees of freedom configured in a symmetric fashion in accordance with an embodiment of the invention.

FIG. 6 conceptually illustrates a system of an arm-like robot in accordance with an embodiment of the invention.

FIG. 7 conceptually illustrates a collection of processes in the memory of an arm-like robot in accordance with an embodiment of the invention.

FIG. 8A graphically illustrates a dexterity index over a workspace that could be expected of an arm-like robot that has six degrees of freedom configured in a non-symmetric fashion in accordance with an embodiment of the invention.

FIG. 8B graphically illustrates a dexterity index over a workspace that could be expected of an arm-like robot that has six degrees of freedom configured in a symmetric fashion in accordance with an embodiment of the invention.

FIG. 9 conceptually illustrates a latching mechanism with three blades and a latching pattern made of three cutouts in a box in accordance with an embodiment of the invention.

FIG. 10 depicts a flow chart illustrating a robot delivering a target to a specified destination in accordance with an embodiment of the invention.

FIG. 11 depicts a flow chart illustrating a robot latching to and unlatching from a target in accordance with an embodiment of the invention.

FIG. 12 conceptually illustrates a latching mechanism with two blades in accordance with an embodiment of the invention.

FIGS. 13A-13B conceptually illustrates a latching mechanism with three blades and a latching pattern with three cutouts in accordance with an embodiment of the invention.

FIG. 14 photographs a latching mechanism with three blades which is fully engaged to a latching pattern with three slots in accordance with an embodiment of the invention.

FIG. 15 depicts a flow chart illustrating a latching mechanism fully engaging to a latching pattern in accordance with an embodiment of the invention.

FIG. 16 depicts a flow chart illustrating an, initially misaligned, latching mechanism self-correcting in order to latch to a target in accordance with an embodiment of the invention.

FIG. 17A photographs a latching mechanism with two blades and a locking mechanism in accordance with an embodiment of the invention.

FIG. 17B photographs a latching mechanism with two blades, an extended locking mechanism, and a latching pattern with two slots in accordance with an embodiment of the invention.

FIG. 18 depicts a flow chart illustrating a latching mechanism locking to a latching pattern in accordance with an embodiment of the invention.

FIG. 19 conceptually illustrates a box with two arm-like robots attached to it being stacked on top of another box in accordance with an embodiment of the invention.

FIG. 20 conceptually illustrates a box with four arm-like robots attached to it in accordance with an embodiment of the invention.

FIG. 21 conceptually illustrates a box with four arm-like robots attached to it using latching patterns that are cut into the box in accordance with an embodiment of the invention.

FIG. 22 depicts a flow chart illustrating multiple arm-like robots cooperating to deliver a target to a specified destination by a centralized controller in accordance with an embodiment of the invention.

FIG. 23 depicts a system overview illustrating a last-mile delivery system in accordance with an embodiment of the invention.

FIG. 24 conceptually illustrates a last-mile delivery system in accordance with an embodiment of the invention.

### DETAILED DESCRIPTION

Turning now to the drawings, systems and methods for last-mile delivery, incorporating modular robots configured in accordance with various embodiments of the invention, are illustrated. In many embodiments, arm-like robots may be utilized that include (but are not limited to) actuated bodies with two ends. In a number of embodiments, the arm-like robots may, additionally or alternatively, include one or more end-effectors and/or motorized wheels at each end. End-effectors configured in accordance with certain embodiments of the invention may include tools that are capable of interacting with and manipulating objects. In several embodiments, the arm-like robots may, additionally or alternatively, include base and elbow motors that move the actuated joints of the body, and wrist motors that rotate the orientation of the ends.

In several embodiments, an end-effector may include a rotating latching mechanism with two or more sloped blades, spacers that constrain the blades to linear movements as the latching mechanism rotates, a locking mechanism that extends from the latching mechanism, and/or a sensor to determine whether the locking mechanism is ready to be extended. In various embodiments, the latching mechanism can rotate the blades into a latching pattern surface on an object until rotational movement is fully constrained. Additionally or alternatively, the sensor can (subsequently) signal that the locking mechanism is ready to be extended. Additionally or alternatively, the locking mechanism can (subsequently) extend through the latching pattern surface to connect the latching mechanism and object together.

In certain embodiments, multiple arm-like robots may be capable of coordinating their actions. Each arm-like robot can include a communication system, which the arm-like robot can use to communicate and coordinate behavior with other arm-like robots. In many embodiments, multiple arm-like robots can connect to and manipulate objects, treating the objects as the body of a cooperative robotic system. In some embodiments, multiple arm-like robots can operate cooperatively to move an object, such as (but not limited to) a package incorporating latching pattern surfaces. In many embodiments, arm-like robots can connect to latching pattern surfaces on packages and move in a coordinated fashion to transport the packages (e.g. to deliver the package to a specific destination).

Proposed solutions for last-mile delivery robots usually only solve a subset of the actual problem. For example, the Starship robot by Starship Technologies OU is a six-wheeled delivery robot that requires couriers and/or businesses to place packages in its cargo bay and recipients to remove the package on arrival. The robot may be only responsible for package transportation. Other wheeled robots can handle even more specialized tasks, including but not limited to the Forklift Mobile Robot by Hangzhou Hikrobot Co. Ltd., which may operate in warehouses and sorts packages by moving the shelves they are stored in. Wheeled robots can often struggle with handling tasks in uncertain environments in the context of delivery logistics. Furthermore, the fact that wheeled robots are constrained to move on planar surfaces can often lead to the need for complex coordination and planning to avoid bottlenecks.

Wheeled systems can typically ground robot delivery systems, thereby reducing the overall operational space at any given moment for other robots to use. The smaller the available region, the more of a necessity proper coordination is in order to maintain efficient robot use. When too many robots are confined in a small space, multiple-wheeled robots can become more inefficient than a single robot.

Robot systems that handle a wider scope of the delivery process can be much larger and more complex. Quadrupeds such as ANYmal by ANYbotics, a four-legged robot, have the ability to traverse many different types of terrain that a wheeled robot cannot operate on. They can also possess the ability to move in different ways, such as twisting their body to unload a package on the ground. ANYmal has further been modified with wheels to provide the benefits of quicker locomotion over flat ground. Quadrupeds can be viewed as more stable, less complex versions of humanoid robots since two of their legs can be converted to arms. This could be ideal since humanoid robots could theoretically traverse and accomplish similar tasks as humans. Humanoid robotic platforms, such as Digit by Agility Robotics Inc., are being actively developed for last-mile delivery.

A major drawback of legged systems is that they typically have a higher energy cost of transport compared to wheeled robots, reducing the number of deliveries a legged robot can perform before a required recharge. In the context of last-mile delivery systems, the space occupied by a legged robot within a delivery vehicle can be significant and is space that could otherwise be devoted to more packages. This can have a compounding effect of reducing the total capacity of packages per delivery that an automated delivery vehicle can handle. Thus, for last-mile delivery, legged systems may not be cost-efficient enough for adoption.

### Robotic Arms

Arm-like robots configured in accordance with some embodiments of the invention can have latching mechanisms and wheels at each end. In a number of embodiments, the latches can allow either side of an arm-like robot to anchor onto a surface to become the base of the robot. In several embodiments, the wheels can be used for locomotion. Each arm-like robot can act as an appendage that can take on a variety of roles by latching its base link to any of a variety of surfaces. In many embodiments, multiple arm-like robots can cooperate and take on different roles to achieve a goal in an efficient manner. In certain embodiments, two arm-like robots can operate in coordination to lift and/or move objects. In a number of embodiments, four arm-like robots can couple together either directly and/or via attaching to an object to form a quadrupedal robot. As can readily be appreciated the specific manner in which multiple arm-like robots can act in a coordinated manner to achieve the functionality of a robot with multiple manipulators and/or legs is not limited to any specific configuration and can be determined based upon the requirements of specific applications.

In several embodiments, arm-like robots may include but are not limited to elbows incorporating double joints. In a number of embodiments, a double joint improves the flexibility of the end-effector in the region near the center axis compared to a traditional six-degree-of-freedom robotic arm.

A traditional six-degree-of-freedom robotic arm typically includes a two-degree-of-freedom base, an elbow joint, and a three-degree-of-freedom wrist with an end-effector. This joint configuration is typically preferred with the base and elbow motors moving the body and elbow(s) while the wrist motor rotates the orientation of the end-effector. The end-effector of a traditional robotic arm usually has low dexterity as it approaches the outer edge of its workspace. The region near the center axis, additionally or alternatively, typically has almost zero dexterity due to the offset between the two joints at the base.

In some embodiments, an arm-like robot can have two joints toward each end of the body and two joints near the elbow, leading to bilateral symmetry. This configuration is similar to a traditional six-degree-of-freedom arm where the elbow has to swing out to reach certain configurations.

A traditional robotic arm with a two-degree-of-freedom base and three-degree-of-freedom wrist is typically optimized to have much of its inertia at its base. When the end actuator and three-degree-of-freedom wrist of a traditional robotic arm becomes the base, the two-degree-of-freedom end (that would then act as the wrist) would become much heavier. A traditional robotic arm with a three-degree-of-freedom base will usually favor one end as the base, have reduced weight capacity of its end-effector, and/or have reduced control over the orientation of the wrist. The design of a traditional robotic arm can introduce functional limitations that inhibit the utilization of the arm as an arm-like robot in which either end of the arm can latch to the environment to form a base for the manipulation of an object by an end-effector at the other end of the arm.

In certain embodiments, an arm-like robot with bilateral symmetry allows for either end to become the base. In many embodiments, the shape and weight of both ends of an arm-like robot are the same, so the weight capacity of the end-effectors and ability to orient the wrists is not limited depending upon which end of the arm-like robot latches to the environment to form a base.

### Latch Alignment

In many embodiments, the end-effectors of arm-like robots may include but are not limited to a latching mechanism. In various embodiments, latching mechanisms can have at least two rotatable blades that are sloped to pull the latching mechanisms closer to a latching pattern surface on an object as the latching mechanism is rotated and spacers that can be used to constrain the blades to linear movement as the latching mechanism is rotated. To prevent radial movement and solidify the connection between the latching mechanism and object(s), many embodiments of the latching mechanism will have a locking mechanism such as (but not limited to) linear pins and/or tabs that extend from the latching mechanism through the latching pattern, allowing an arm-like robot to use the end actuator to rotate while maintaining the fixture to the latching pattern surface. In various embodiments, sensors such as (but not limited to) a light sensor, proximity sensor, and/or video camera can generate sensor signals that can be processed by a controller to determine when the locking mechanisms should extend. In many embodiments, robots, additionally or alternatively, can incorporate components including but not (but is not limited to) a camera, sensor, and/or one or more controllers. Doing so may allow robots to control processes including but not limited to coarsely aligning end-effectors with latching pattern surfaces.

Delivery robots aligning and latching (i.e., connecting) to packages, frequently becomes a bottleneck in delivery processes. Additionally, real-world factors, such as vibrations from delivery vehicle engines and low lighting can lengthen the duration for a successful alignment and latching. Creating reinforced latching pattern surfaces on delivery packages can be expensive, so a low-cost, fast, and accurate alignment and latching solution can be important for successful last-mile delivery systems.

In some embodiments of the invention, latching pattern surfaces on delivery packages may be (e.g., cardboard, plastic, Styrofoam) cutouts on the sides of the packages. These cutouts may match the blade size of the latching mechanisms (of the arm-like robots). In many embodiments, there is a high tolerance for misalignment between the latching mechanism and latching pattern surface due to the sloped blade design of the latching mechanism.

In some embodiments, latching mechanisms may possess (but are not limited to) various (e.g., three) blades that may rotate into cutout patterns of various (e.g., 3) triangular holes. The blades may be sloped so that they are capable of pulling the mechanism(s) closer to the latching surface as the assembly is rotated. Spacers can be used to establish contacts with the edges of the triangular patterns to constrain the blade to linear movements along the edge face as the latching sequence progresses. Once all spacers have made contact with their respective latching pattern edges, the assembly and the cutout patterns can be considered by the controller to be concentrically aligned.

### Multiple Robotic Arms

In certain embodiments, multiple arm-like robots can latch to an object and treat the object as the body of a robotic system. In many embodiments, multiple arm-like robots communicate with a device that sends instructions to coordinate the robotic system. In some embodiments, four arm-like robots latch to a delivery box to create a robotic system, and are sent movement instructions as if the robotic system were a four-legged robot.

Last-mile delivery systems that utilize multiple robots can limit efficiency and space without careful planning and preparation. Multiple-legged robots in a delivery system can be so large that there is less room for packages in a delivery vehicle, making a robotic system less efficient. Robots large enough to manipulate and move packages are, additionally or alternatively, made up of many parts, and have a higher risk of a part breaking than a smaller robot with fewer parts. Multiple robots in a last-mile delivery system are, additionally or alternatively, typically expensive, with the purchasing and maintenance costs being a potential deterrence for delivery companies.

Arm-like robots as described in many embodiments of the invention typically are small and low-cost. In various embodiments, multiple arm-like robots can use a delivery package as a body for a legged robotic system, meaning a delivery vehicle can have more space for packages. Arm-like robots, by virtue of not being made of many parts, can thereby have a lower likelihood of needing maintenance than larger robots. Using robots configured in accordance with multiple embodiments of the invention, delivery companies can have flexibility in how many arm-like robots they deploy with a delivery vehicle given a package manifest, where a manifest is a list of packages that will be delivered by a delivery vehicle.

Various systems and methods for implementing arm-like robots in accordance with a number of different embodiments of the invention are discussed in detail below.

### Arm-Like Robots

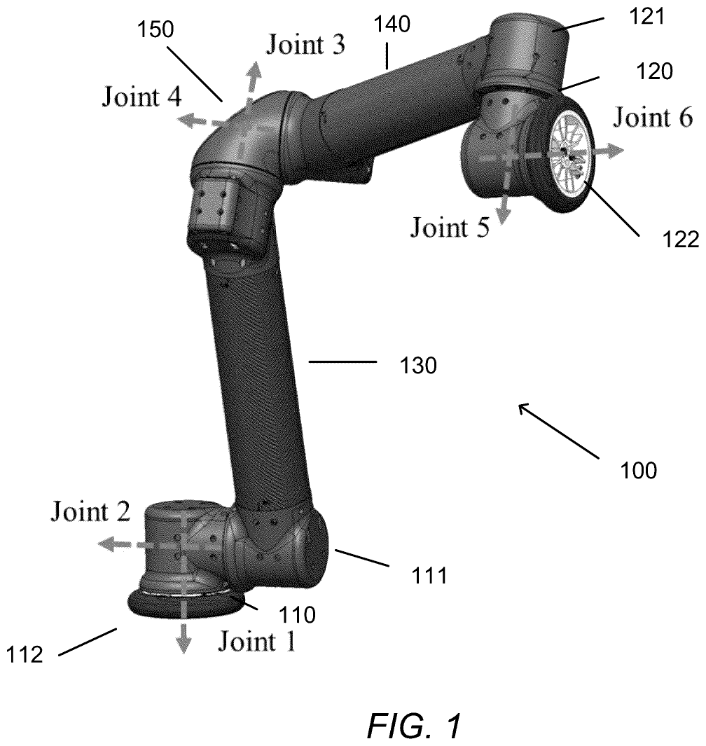

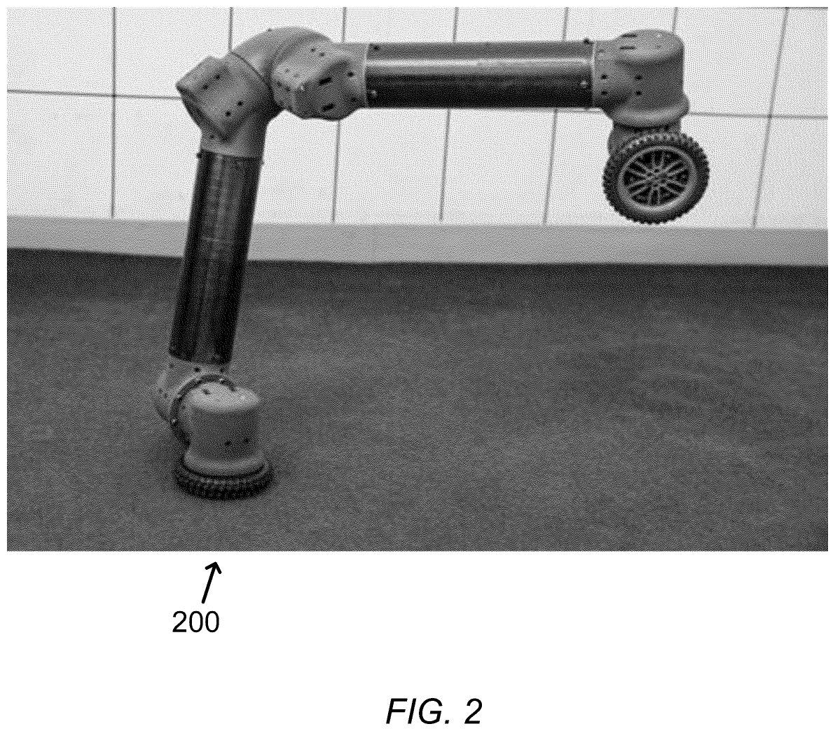

Arm-like robots can be used in a variety of applications and industries. In some embodiments, an arm-like robot may have at least six degrees of freedom. In several embodiments, the arm-like robot may be capable of operating symmetrically. In such cases, either end of the arm-like robot can anchor onto a surface while using the other end of the arm-like robot to manipulate objects. In numerous embodiments, arm-like robots with symmetric designs can self-balance and maneuver across a variety of terrain using wheels located at each end of the arm-like robots and/or by extending their respective arms. FIGS. 1 and 2 illustrate arm-like robots configured in accordance with several embodiments of the invention.

An example arm-like robot configured in accordance with some embodiments of the invention to be capable of being utilized in a symmetric manner is illustrated in FIG. 1. The arm-like robot 100 includes several joints 101-106 that can be capable of (but are not limited to) rotation and/or movement, allowing six degrees of freedom. Joint 101 can rotate end-effector 111 and wheel 112 around wrist 110, giving a first degree of freedom to an arm-like robot. In some embodiments, end-effectors may include (but are not limited to) latching mechanisms, hooks, and/or magnets. In some embodiments, latching mechanisms can include (but are not limited to) two or more rotatable blades. In certain embodiments, arm-like robots may operate and/or manipulate wheels and latching mechanisms with components such as (but not limited to) motors, gearboxes, and/or actuators. Joint 101, additionally or alternatively, can connect to joint 102, which can rotate end-effector 111 and wheel 112 around arm 130, giving a second degree of freedom. Joint 102 connects to joint 103. Arm 130 can rotate around body 150 with joint 103, giving a third degree of freedom. Body 150 can connect to joint 104, which can rotate arm 140, giving a fourth degree of freedom. Joint 105 can connect to arm 140. Joint 105 can, additionally or alternatively, rotate end-effector 121 and wheel 122 around arm 140, giving a fifth degree of freedom. Joint 106 can connect to Joint 105 and can, additionally or alternatively, rotate end-effector 121 and wheel 122 around wrist 120, giving the arm-like robot a sixth degree of freedom.

In certain embodiments, a 90-degree offset between the joints 103 and 104 can couple the position and orientation in a twisting fashion. In some embodiments, due to the pairing of motors, analytic inverse kinematics (IK) can be nontrivial, and numerical IK can be implemented for processes including but not limited to latching, end-effector positioning, and/or joint positioning. In such cases, numerical IK may be implemented using a method such as (but not limited to) the Damped Least Squares method and/or any other method appropriate to the requirements of a specific application. In many embodiments, using non-standard reference frames can preserve symmetry and align the axes at the location of the motor output. In numerous embodiments, reference frames define the position of an object with respect to a robot.

The joint frames used in some embodiments of the invention may not directly follow conventional Denavit-Hartenberg (DH) parameters. In many embodiments, the frame locations and orientations may not need to change in a manner that is dependent upon which end is used as a base. In some embodiments, forward kinematics (FK) transformations in a bilateral symmetric design can be similar in form, and can be defined by reversing the direction of some offset angles when switching bases. The transformation from joint 101 to joint 102, in certain implementations of an arm-like robot (with a symmetric design) can follow the exact same calculation as the transformation from joint 106 to joint 105 (except that the offset rotation around the x-axis can be reversed). In numerous embodiments, this may result in singular FK algorithms with Boolean switches to solve for transformations at either end of given arm-like robots.

An arm-like robot with six degrees of freedom in accordance with some embodiment of the invention, which is similar to the arm-like robot shown in FIG. 1, is photographed in FIG. 2. Similarly, this arm-like robot 200 has six degrees of freedom in a symmetric fashion.

Additional attributes of arm-like robots implemented in accordance with many embodiments of the invention are disclosed in the papers listed in the appendix: “Feasibility Study of LIMMS, A Multi-Agent Modular Robotic Delivery System with Various Locomotion and Manipulation Modes”; “Latching Intelligent Modular Mobility System for Logistics and Last-Mile Delivery”; “Self-Aligning Rotational Latching Mechanisms”; “Self-Aligning Rotational Latching Mechanisms: Optimal Geometry for Mechanical Robustness”; Self-Aligning Rotational Latching Mechanisms: A Framework Extension For Orientations & Fast Latching”; and “Kinematics Analysis On Optimal Geometry For Robust Latching And Increased Load Capacity For LIMMS: A Modular, Multi-Modal Robotic System,” the disclosures for which are incorporated by reference in their entireties.

While specific implementations of an arm-like robot with six degrees of freedom have been described above with respect to FIGS. 1 and 2, there are numerous configurations of an arm-like robot, including, but not limited to, those using an arm-like robot with two-degrees-of-freedom bases, three-degrees-of-freedom manipulators extending from each base, and/or any other configuration that can be utilized as appropriate to the requirements of a given application in accordance with various embodiments of the invention.

### Modular Robotic Delivery Systems

Arm-like robots, having configurations similar to the robots shown in FIGS. 1 and 2, can be utilized in last-mile delivery systems implemented in accordance with various embodiments of the invention. In many embodiments, a last-mile delivery system involves traversing a variety of terrain including (but not limited to) lawns, stairs, sidewalks, roads, gravel, dirt, and/or rocks. In some embodiments, last-mile delivery can incorporate (but is not limited to) robots that sort packages in a delivery vehicle, robots that deliver packages to a front door but require a human to remove the package from the robot, and/or a self-driving delivery vehicle. As can readily be appreciated, the specific robots and the degree of autonomy largely depend upon the requirements of a given application. Furthermore, while the systems that are described below are discussed in the context of last-mile delivery, it can readily be appreciated that the robotic systems described herein can be utilized in any of a variety of applications involving the movement of objects including (but not limited to) logistics, and/or factory assembly.

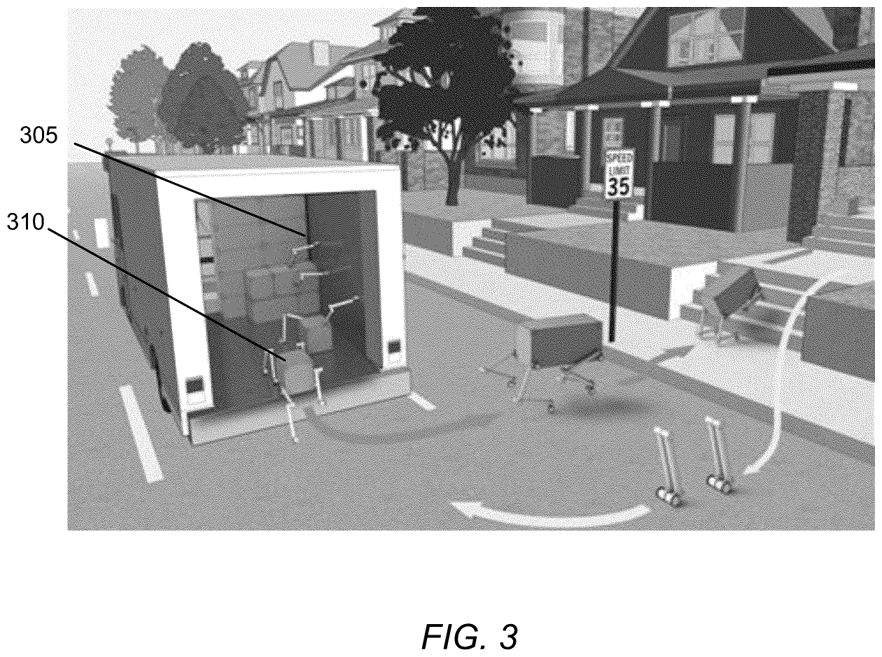

A concept of a last-mile delivery system incorporating modular robotics in accordance with some embodiments of the invention is illustrated in FIG. 3. The last-mile delivery system includes a vehicle and arm-like robots 305 delivering a package to a destination. In many embodiments, the delivery vehicle has latching patterns on its side, floor, and/or roof that provide anchor points for arm-like robots 305. While arm-like robots 305 are anchored to the delivery vehicle, they can latch to a package 310 and maneuver it. Multiple arm-like robots 305 can coordinate to attach to a package 310, exit the delivery vehicle, maneuver across a variety of terrain including (but not limited to) flat roads, stairs, and/or lawns, and deliver the package to a destination. Once the package 310 is delivered, the arm-like robots 305 can detach from the package 310 and return to the delivery vehicle separately. In some embodiments, the arm-like robots can return to the delivery vehicle while attached together. In certain embodiments, the arm-like robots 305 can attach to each other by latching together. Additionally or alternatively, in various embodiments, the arm-like robots 305 may attach via magnetic coupling and/or by hooking together. In a number of embodiments, the arm-like robots 305 can adopt a pose in which they can maneuver via two-wheeled (and/or bipedal) motion.

While specific implementations of last-mile delivery systems are described above with respect to FIG. 3, there are numerous configurations of last-mile delivery systems, including, but not limited to, those using wheeled robots and/or humans as appropriate to the requirements of specific applications in accordance with various embodiments of the invention.

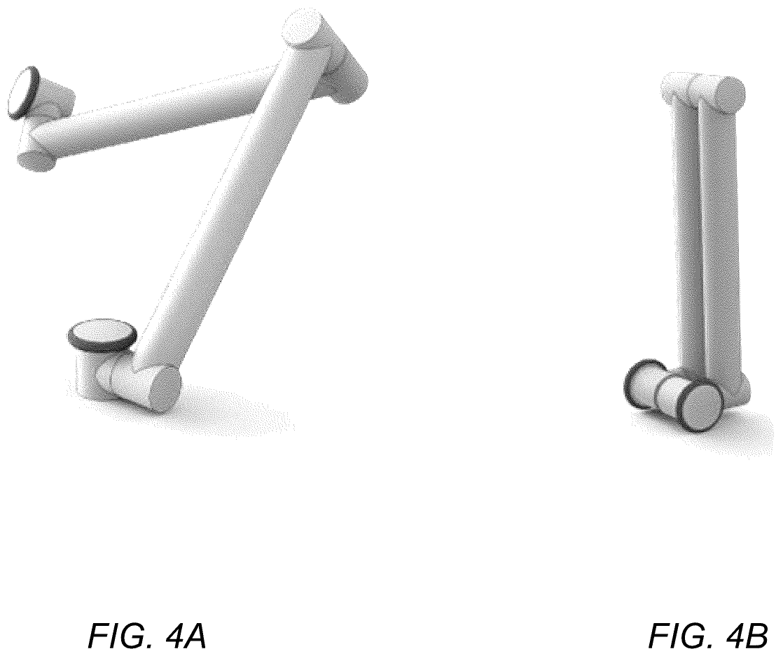

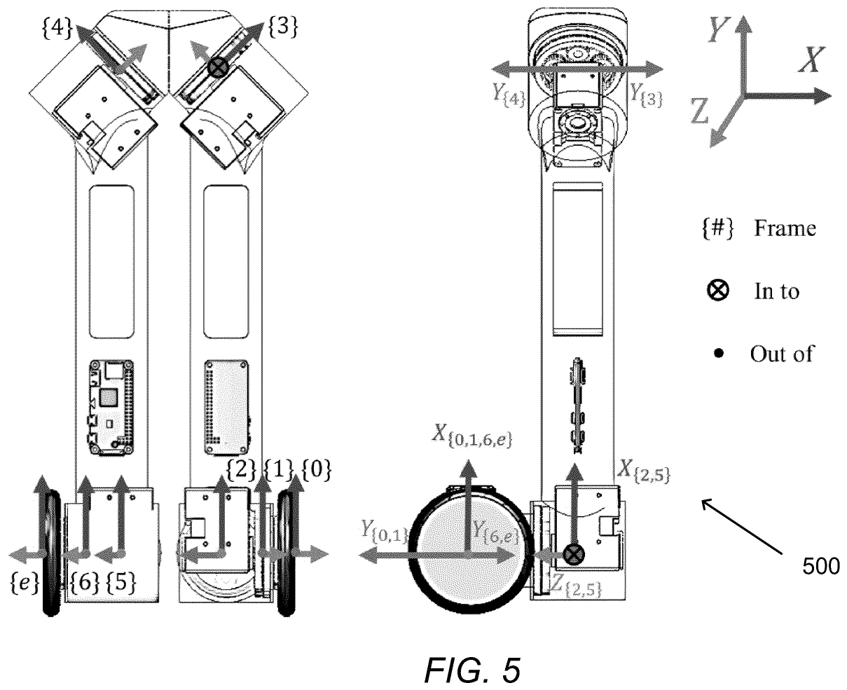

Multiple configurations of an arm-like robot (e.g., with six degrees of freedom) symmetrically configured in accordance with several embodiments of the invention are illustrated in FIG. 4A and FIG. 4B. FIG. 4A illustrates an arm-like robot configured symmetrically in an extended pose, which may enable the robot to have seven degrees of freedom and seven joints. In some embodiments, tasks that require a large range of motion can be accomplished by arm-like robots in an extended pose. In many embodiments, the arm-like robot can self-balance while rolling on one or more wheels. FIG. 4B illustrates an arm-like robot (with seven degrees of freedom and seven joints) configured in a wheeled motion pose with two wheels positioned side by side for movement.

While specific implementations of an arm-like robot are described above with respect to FIGS. 4A and 4B, there are numerous configurations of an arm-like robot, including, but not limited to, those using an arm-like robot with a two-degree-of-freedom base and three-degree-of-freedom manipulators extending from each base, and/or any other configuration appropriate to the requirements of a given application in accordance with various embodiments of the invention.

### Arm-Like Robot Components

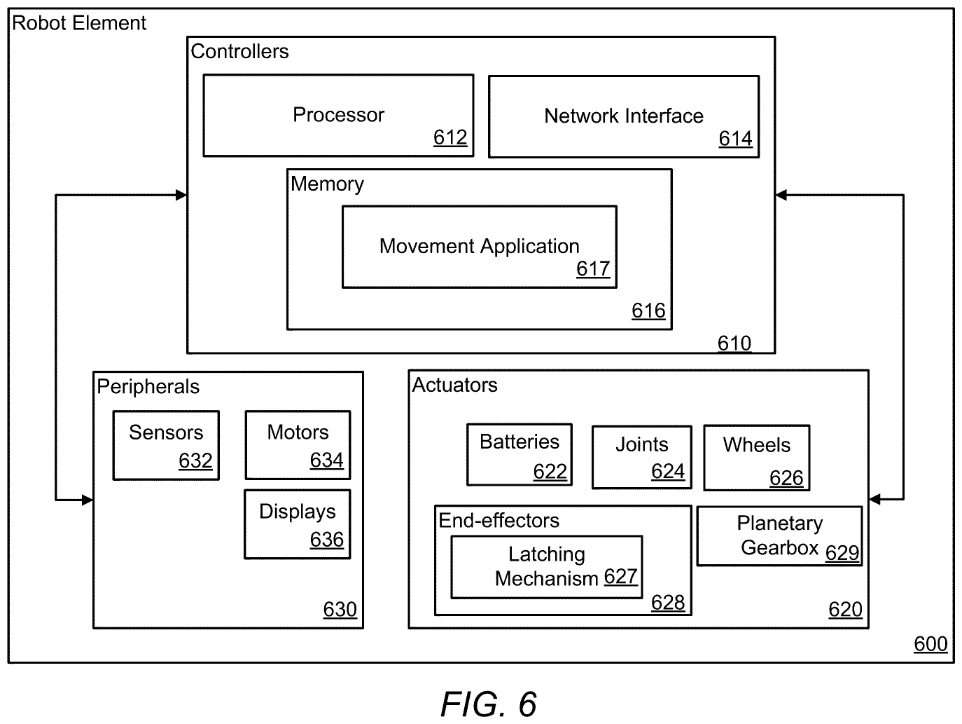

In accordance with many embodiments of the invention, arm-like robots can incorporate components including (but not limited to) controllers, peripherals, and/or actuators. In some embodiments, controllers may include (but are not limited to) processors, network interfaces, and/or memory. In certain embodiments, memory can contain applications such as (but not limited to) movement applications, communication applications, image processing applications, control processes, camera processes, visualizer processes, and/or motor processes. In many embodiments, peripherals can include (but are not limited to) sensors, and/or displays. In additional embodiments, actuators may include (but are not limited to) batteries, joints, wheels, latching mechanisms, end-effectors, motors, and/or planetary gearboxes. FIGS. 5, 6, and 7 illustrate these components in accordance with various embodiments of the invention.

Yet another example of an arm-like robot with six degrees of freedom that is capable of operating in a symmetric fashion in accordance with certain embodiments of the invention is illustrated in FIG. 5. In the illustrated embodiment, the robot 500 has non-traditional Denavit-Hartenberg joint frames. In certain embodiments, these frames can preserve symmetry and align the axes at the location of a motor output. The non-traditional frames, additionally or alternatively, may not change regardless of which end of the robot is used as a base in various embodiments. While specific implementations of arm-like robots are described with respect to FIG. 5, there are numerous configurations of arm-like robots, including, but not limited to, a robot with a two-degree-of-freedom base and/or a three-degree-of-freedom manipulator, and/or any other configuration that can be utilized as appropriate to the requirements of a given application in accordance with various embodiments of the invention.

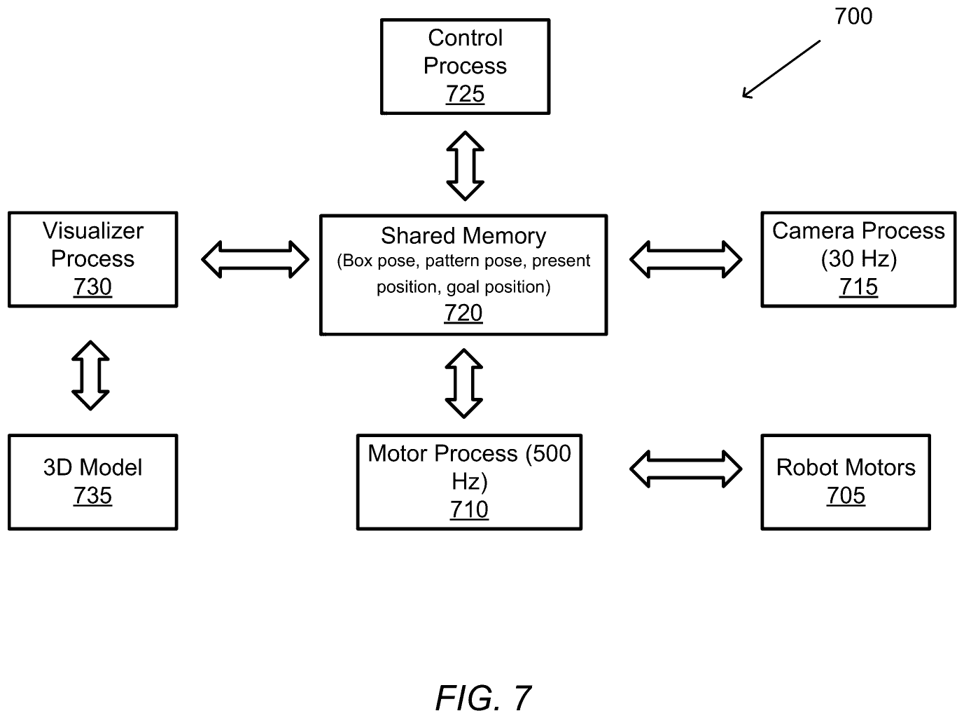

An example of a robot controller element that executes instructions to perform processes that latch to and manipulate packages in accordance with multiple embodiments of the invention is illustrated in FIG. 6. Robots in accordance with many embodiments of the invention can include (but are not limited to) one or more of mobile devices, cameras, and/or computers. In the illustrated embodiment, the robot 600 includes one or more controllers 610, peripherals 630, and actuators 620. One skilled in the art will recognize that a robot implemented in accordance with various embodiments of the invention may exclude certain components and/or include other components that are omitted for brevity without departing from the scope of this invention.

The one or more controllers 610 can include (but are not limited to) a processor 612 and/or network interface 614 that can execute instructions stored in a memory 616 to manipulate data stored in the memory 616. Processor instructions can configure the processor 612 to perform processes in accordance with certain embodiments of the invention, such as processes for (but not limited to) latching to objects, operating as a two-wheeled robot, and/or coordinating with multiple arm-like robots. In various embodiments, processor instructions can be stored in a non-transitory machine-readable medium. Controllers 610 can receive input and instruct peripherals 630 and actuators 620 to perform specific tasks. In various embodiments, controllers 610 can receive input from peripherals 630 to instruct actuators 620. In several embodiments, a robot 600 can utilize network interface 615 to transmit and receive data over a network based upon instructions performed by a processor 612 contained in the one or more controllers 610.

In many embodiments, the memory 616 includes a movement application 617. Movement applications in accordance with several embodiments of the invention can be executed on one or more processors to control and manipulate the peripherals 630 and actuators 620 of a robot.

Peripherals 630 can include any and/or a variety of components for robot functions, such as (but not limited to) sensors 632, and/or displays 636. Sensors 632 can include any of a variety of components for capturing data, such as (but not limited to) cameras, light sensors, sound sensors, etc. In a variety of embodiments, peripherals can be used to gather inputs and/or provide outputs. Displays 636 can visualize data and output. Peripherals in accordance with many embodiments of the invention can be used to gather inputs that can be used to latch to and manipulate packages. As can readily be appreciated, the specific set of peripherals utilized within a given robot implemented in accordance with many embodiments of the invention is largely dependent upon the requirements of a given application.

Actuators 620 can include any variety of mechanical and/or electronic components for robot functions, such as (but not limited to) batteries 622, joints 624, wheels 626, end-effectors 628, motors 634, and/or planetary gearboxes 629. Batteries 622 can be rechargeable using AC power, DC power, and/or solar power. In many embodiments, there can be six joints 624 on a robot that enable movement and rotation. As can readily be appreciated, the number of joints is largely dependent upon the desired degrees of freedom for the robot to meet the requirements of a specific application. Wheels 626 can be made of a variety of materials, such as (but not limited to) rubber, plastic, metal, and/or wood. End-effectors 628 can have (but are not limited to) a latching mechanism 627. The latching mechanism 627 can be (but is not limited to) a rotational mechanism with two or more blades, a hook, and/or a magnet. As can readily be appreciated, the specific latching mechanism that is utilized is largely dependent upon the requirements of a given application. Although specific robots 600 are described with reference to FIG. 6, robots can be implemented using any of a variety of components as appropriate to the requirements of specific applications in accordance with various embodiments of the invention.

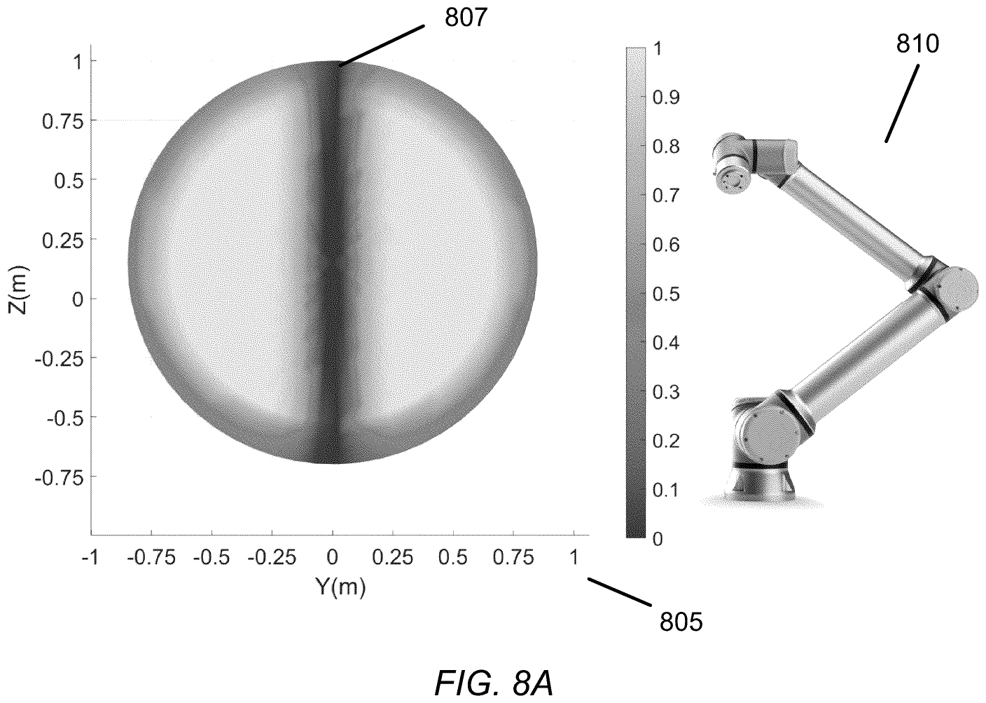

A conceptual illustration of the operation of an arm-like robot in accordance with several embodiments of the invention is illustrated in FIG. 7. The robot 700 can include (but is not limited to) controllers, actuators, and/or peripherals in a manner similar to that described above with reference to FIG. 6. In the example illustrated in the figure, instructions are stored in a shared memory 720 that can be executed to configure the robot 700 to perform processes in accordance with certain embodiments of the invention.

In accordance with multiple embodiments, a motor process 710 is conceptually illustrated that can be utilized to control the individual motors 705 within the joints of the robot. A higher-level control process 725 can coordinate the movement of the specific motors by providing instructions to the motor process 710. In several embodiments, the control process 725 can transmit and receive instructions from one or more additional robots (not shown) over a wireless communication network. In this way, the control process 725 can coordinate the movement of the robot in cooperation with the movement of other similar robots.

In several embodiments, the shared memory 720 may include additional instructions. For example, the shared memory 720. additionally or alternatively, may include instructions for a sensor (e.g., camera) process 715 that can obtain sensor information regarding the environment in which the robot 700 operates. In various embodiments, the shared memory 720, additionally or alternatively, can include a visualizer process 730 that may enable the robot 700 to build a 3D model 735 of the robot 700 and its operating environment. In multiple embodiments, the visualizer process 730 can be utilized to perform high-level motion planning. For example, the visualizer process 730 can provide motion plans to the control process 725, which can (additionally or alternatively) send instructions to the motor process 710 to actuate individual motors within the robot 700.

Although specific software architectures for arm-like robots are described above with reference to FIG. 7, any of a variety of software architectures can be utilized to implement the control processes utilized by a robot for performing behaviors including, but not limited to, the movement of the robot, the anchoring of an end of the robot to form a base, and/or the movement of an object as appropriate to the requirements of specific applications in accordance with various embodiments of the invention.

### End-Effector Manipulation

Arm-like robots with symmetric designs implemented in accordance with certain embodiments of the invention can have greater dexterity, over a workspace, than their non-symmetric counterparts. This can be reflected in a dexterity index that represents the dexterity that an arm-like robot has over a workspace, with zero dexterity meaning an inability for a given arm-like robot to maneuver to some portion of a workspace. In order to manipulate and latch to packages in a last-mile delivery system, systems in accordance with many embodiments of the invention may need an arm-like robot to have a high dexterity index, specifically since arm-like robots may connect to/disconnect from varying surfaces and packages. Arm-like robots with high dexterity indices (and latching mechanisms and latching patterns that securely align and latch quickly) as found in many embodiments of the invention are described in the figures below.

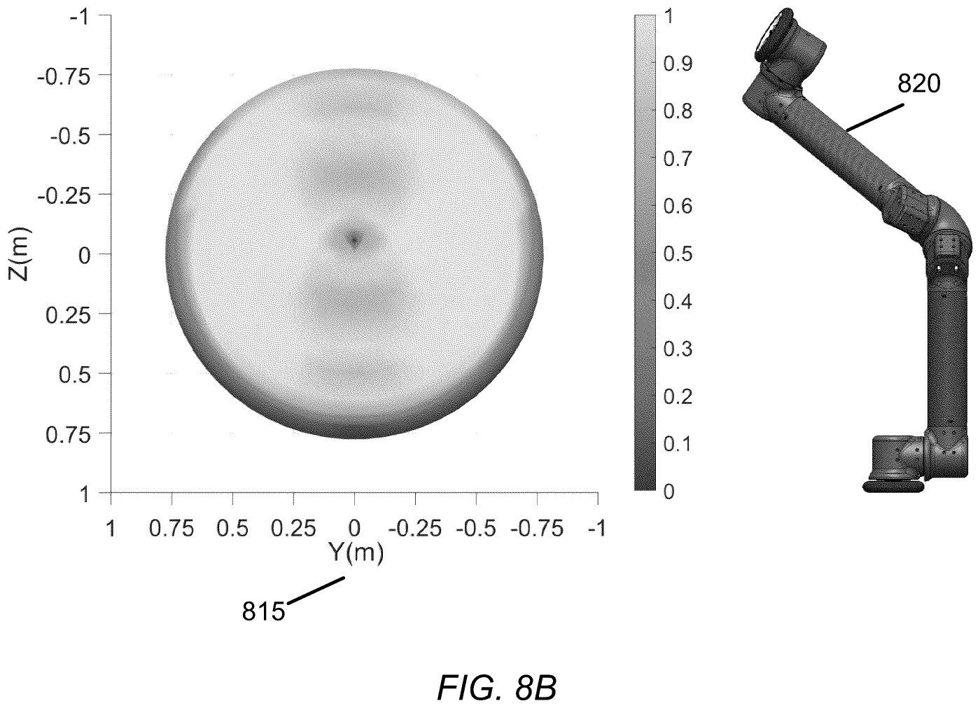

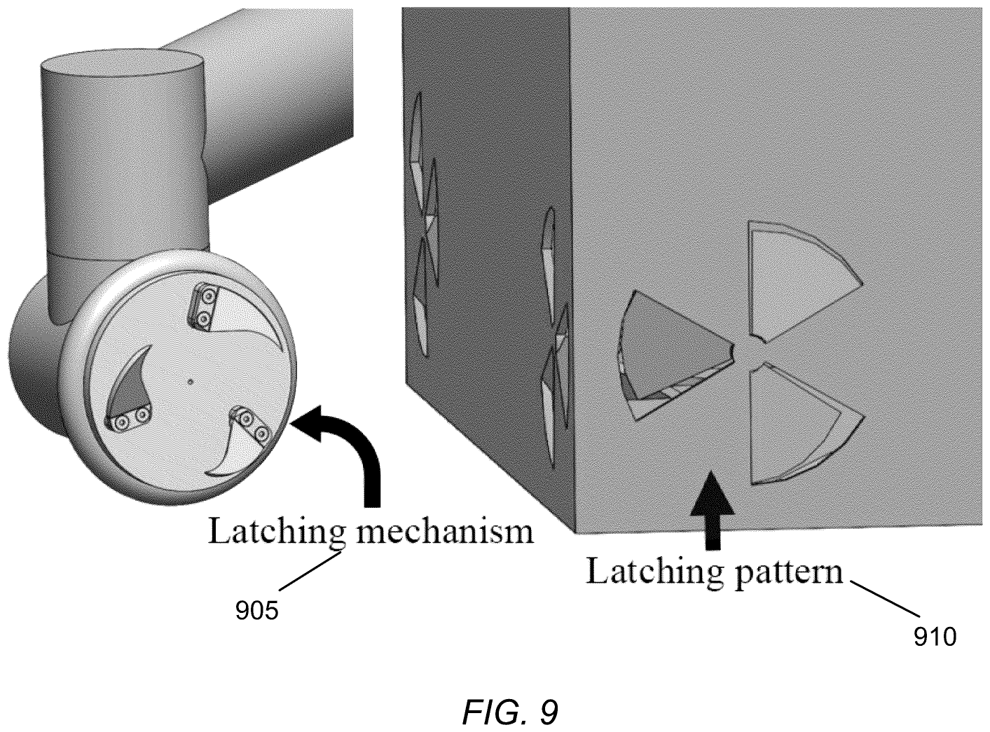

A visualization of the dexterity index of six-degree-of-freedom arm-like robots, configured in accordance with many embodiments of the invention, are illustrated in FIGS. 8A-8B. The dexterity indices within the workspace for a non-symmetric (six-degree-of-freedom) arm-like robot 810 and a symmetric (six-degree-of-freedom) arm-like robot 820 are shown in charts 805 and 815 respectively. The chart 805 for the non-symmetric arm-like robot 810 in FIG. 8A illustrates that it has zero dexterity in the region near a center axis 807 due to the offset between the two joints at the base. By contrast, the chart 815 for the symmetric arm-like robot 820 in FIG. 8B illustrates that it has more dexterity than the non-symmetric arm-like robot at the region near the center axis. Even though the symmetric and non-symmetric arm-like robots have similar base configurations, the double joint at the elbow of the symmetric arm-like robot improves the flexibility of the end-effector in the region near the center axis.

While specific implementations of arm-like robots are described above with respect to FIGS. 8A-8B, there are numerous configurations of an arm-like robot, including, but not limited to, those using an arm-like robot with two-degree-of-freedom base(s) and three-degrees-of-freedom manipulator(s) extending from each base, and/or any other configuration that can be utilized as appropriate to the requirements of a given application in accordance with various embodiments of the invention.

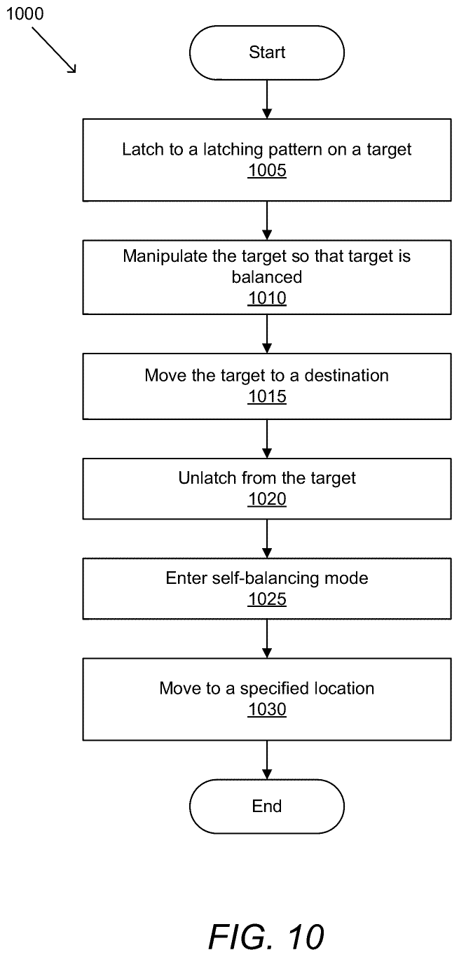

An example of a latching mechanism, and a latching pattern, implemented in accordance with many embodiments of the invention is illustrated in FIG. 9. The illustrated scene shows a latching mechanism 905 of an end-effector of a robot and a latching pattern 910 on a cardboard box. The latching mechanism 905 is attached to an end-effector of a robot. In some embodiments, latching mechanisms 905 may be attached to one or more other devices that can be manipulated manually and/or electronically. In various embodiments, the latching mechanisms 905 may have two or more blades attached to rotatable center islands. In many embodiments, latching mechanisms 905 can include (but are not limited to) hooks, magnets, and/or loops. In numerous embodiments of the invention, latching mechanisms 905 may contain one or more sensors to identify latching patterns. Sensors may include (but are not limited to) light sensors, cameras, and/or depth sensors. In various embodiments of the invention, latching patterns 910 may be cut out of surfaces including but not limited to cardboard, plastic, and styrofoam. In multiple embodiments, the latching patterns 910 may include but are not limited to hole inserts and/or collections of slits (e.g., in a box).

While specific latching mechanisms and latching patterns are described above with respect to FIG. 9, any of a variety of latching mechanisms and latching patterns, including, but not limited to, a first touch fastener such as a hook and loop fastener, and/or any other configuration can be utilized as appropriate to the requirements of a given application in accordance with various embodiments of the invention.

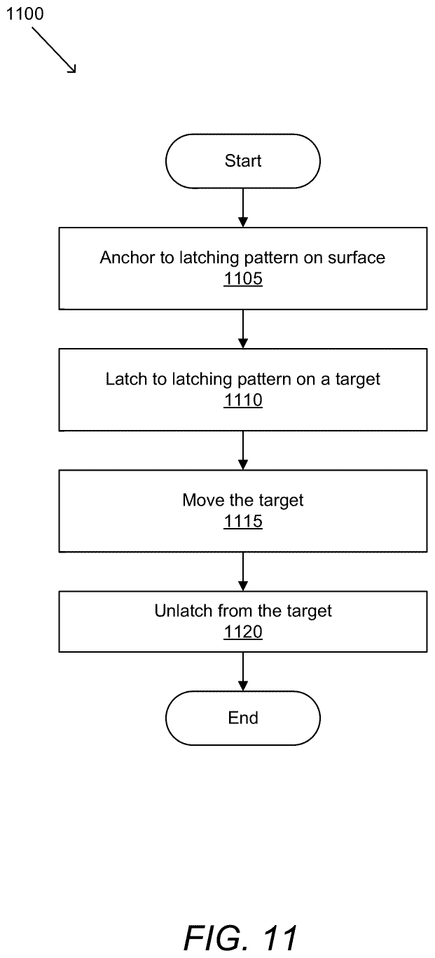

A process for manipulating a target (e.g., delivery box and/or latching point on delivery vehicle) using arm-like robots configured in accordance with certain embodiments of the invention is illustrated in FIG. 10. The process 1000 latches (1005) onto a latching pattern on a target. Techniques for latching onto latching patterns. in accordance with several embodiments of the invention, can include (but are not limited to) hooking, rotating, magnetizing, and/or inserting. In numerous embodiments, latching patterns may include (but are not limited to) cutouts, hole inserts (e.g., plastic, cardboard), magnets, and/or loops. In many embodiments, targets may include but are not limited to boxes and/or any objects which can be manipulated.

The process 1000 manipulates 1010 the target so that the target is secured to the robot. In some embodiments, securing targets to robots may be complete when the robots can use a wheel to move the robots and the targets. In various embodiments, multiple robots can cooperate together to manipulate individual targets. Process 1000 moves (1015) the target to a destination. In several embodiments, potential destinations may take the form of (but are not limited to) the area(s) in front of building(s) and/or predefined location(s). Process 1000 unlatches (1020) from the target. Process 1000 enters (1025) a self-balancing mode. In some embodiments, self-balancing modes may take forms similar to (underactuated) two-wheeled mobile robots including but not limited to Segways. In various embodiments, robots can connect together with others to enter self-balancing modes and/or can be self-balancing on singular wheels. Process 1000 moves (1030) to a specified (end) location. In some embodiments, specified locations may include but are not limited to delivery vehicles, storage buildings, and predefined locations.

While specific processes for manipulating a target using an arm-like robot are described above with respect to FIG. 10, any of a variety of processes can be utilized to latch to form a base and/or move an object using an arm-like robot capable of symmetric operation as appropriate to the requirements of specific applications in accordance with various embodiments of the invention. In several embodiments, steps may be executed or performed in any order or sequence not limited to the order and sequence shown and described. In numerous embodiments, some of the above steps may be executed or performed substantially simultaneously where appropriate or in parallel to reduce latency and processing times. In some embodiments, one or more of the above steps may be omitted.

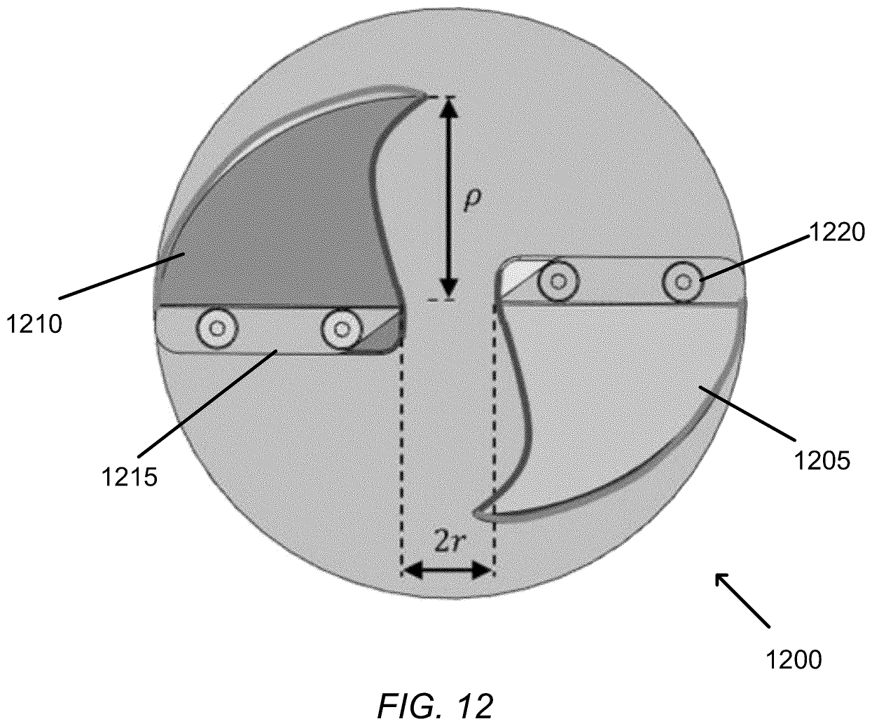

A process for moving a target using an arm-like robot capable of attaching to a surface in accordance with numerous embodiments of the invention is illustrated in FIG. 11. Process 1100 anchors (1105) to a latching pattern on a surface. Such surfaces can include (but are not limited to) walls, floors and/or roofs of a vehicle, building, etc. In some embodiments, a surface is a side of a delivery vehicle. Process 1100 latch (1110) to a latching pattern on a target. In various embodiments, a target is a cardboard delivery box. The specific target may typically be dependent upon the requirements of a particular application. Process 1100 moves (1115) the target. In some embodiments, robots may be configured for operations including but not limited to moving a delivery box on top of other boxes (e.g., to free up space inside of a delivery vehicle), moving a delivery box to an exit of a delivery vehicle (e.g., to stage the delivery box for delivery), and/or moving (and/or holding) a delivery box so that another robot can also latch onto the delivery box.

Process 1100 unlatches (1120) from the target. As noted above, robots can be configured to unlatch from targets in scenarios including (but not limited to) when they are delivered to a desired location and/or because another robot has signaled intent to utilize the latching pattern on the target (e.g., in order to be able to move the target itself).

While specific processes for moving targets using arm-like robots capable of attaching to surfaces are described above with respect to FIG. 11, any of a variety of processes can be utilized to latch to a surface to form a base and/or move an object using an arm-like robot capable of symmetric operation as appropriate to the requirements of specific applications in accordance with various embodiments of the invention. In many embodiments, steps may be executed or performed in any order or sequence not limited to the order and sequence shown and described. In various embodiments, some of the above steps may be executed or performed substantially simultaneously where appropriate or in parallel to reduce latency and processing times. In some embodiments, one or more of the above steps may be omitted.

### Latching Mechanism

In many embodiments of the invention, latching mechanisms configured with a plurality of blades can quickly align and latch to latching patterns formed on the surface of a target such as (but not limited to) a delivery package. In certain embodiments, last-mile delivery systems may require robots to have the capability to quickly connect to and/or disconnect from packages (e.g., in order to move them from a delivery vehicle to a destination). In various embodiments, latching mechanisms and latching patterns (e.g., on the surface of the delivery package) may be mechanically constrained from movement once a latching sequence is complete. The discussion that follows describes a variety of latching mechanisms in accordance with various embodiments of the invention.

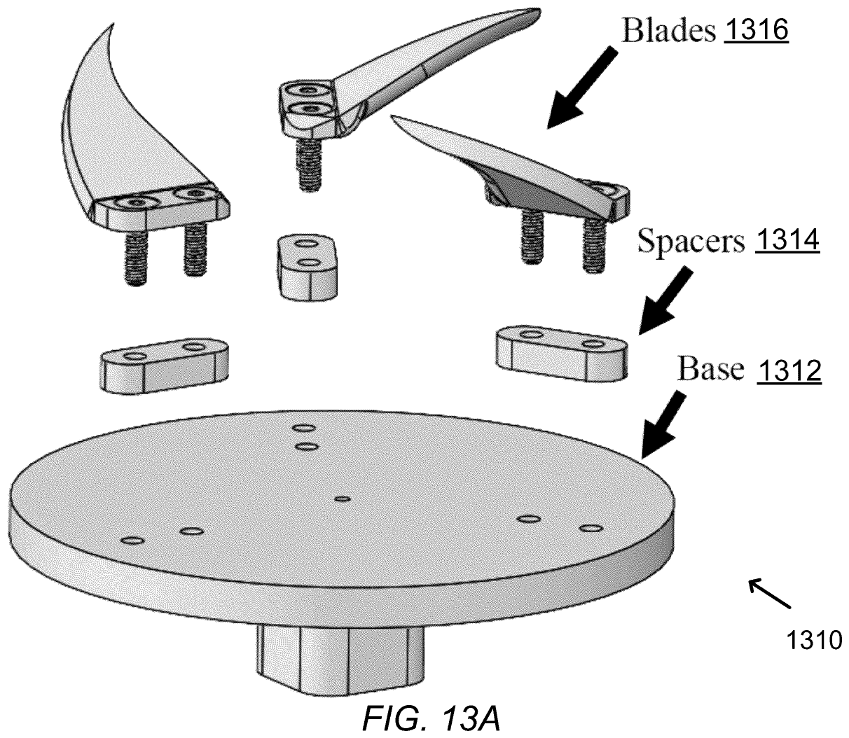

A latching mechanism, incorporating two blades, configured in accordance with certain embodiments of the invention is illustrated in FIG. 12. The latching mechanism 1200 is circular and incorporates two blades 1205, 1210. In some embodiments, a first blade 1205 and/or a second blade 1210 may rotate until it is fully engaged with (e.g., a cutout in) a latching pattern. In various embodiments, fully engaged may refer to latching mechanisms no longer being able to move in the direction of engagement which involves rotation of the latching mechanism. The first blade is connected to a base 1215 by connectors 1220. The second blade 1210 is attached in a similar manner. In many embodiments, connectors can include (but are not limited to) screws, bolts, etc.

While specific implementations of a latching mechanism with two blades are described above with respect to FIG. 12, there are numerous configurations of latching mechanisms, including, but not limited to, latching mechanisms with three or more blades, and/or any other configurations that can be utilized as appropriate to the requirements of a given application.

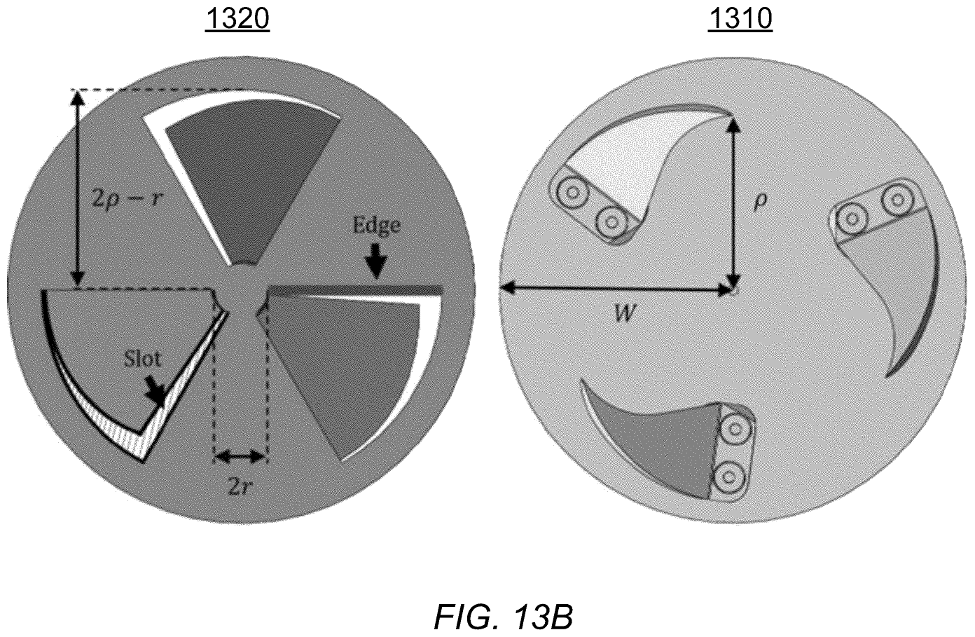

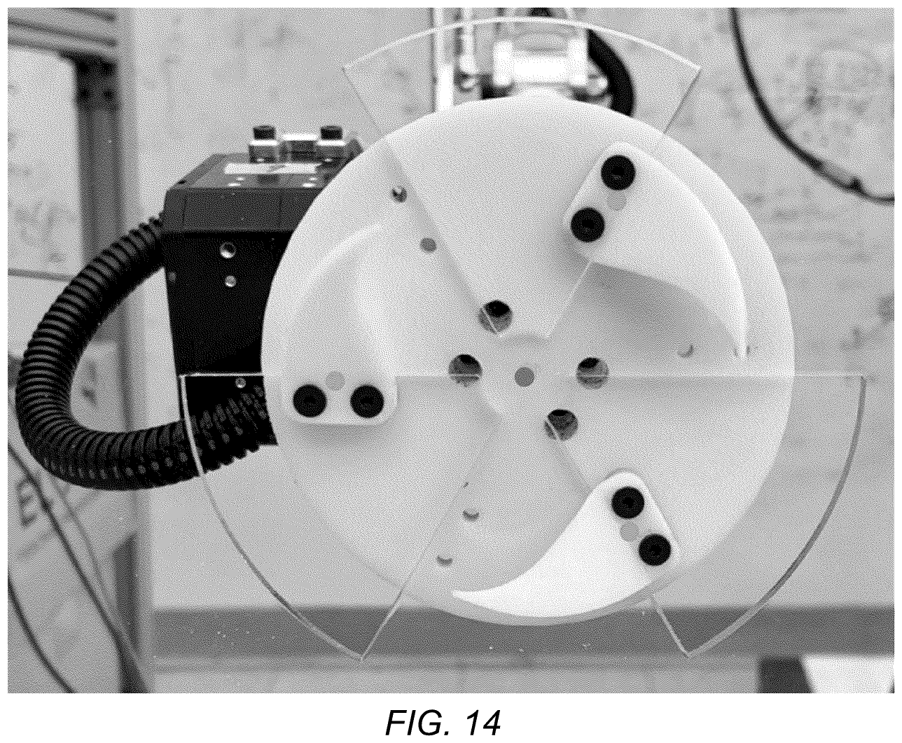

Examples of a latching mechanism with three blades (and a latching pattern with three cutouts) implemented in accordance with some embodiments of the invention are conceptually illustrated in FIGS. 13A-14.

FIG. 13A illustrates an example of the components of a latching mechanism incorporating three blades in accordance with many embodiments of the invention. The component set for the latching mechanism 1310 includes a base 1312 that includes holes formed so that pins and/or screws can be used to attach spacers 1314 and blades 1316 to the base. In some embodiments, the spacers help a latching mechanism fully engage with a latching pattern. In various embodiments, the spacers help one or more misaligned blades successfully align with a slot in a latching pattern. In many embodiments, the blades, spacers, and base are a single component. In many embodiments, the specific structure of the base and/or blades of the latching mechanism are determined based upon the requirements of specific applications. FIG. 13B illustrates the latching mechanism 1310 and an example of latching pattern 1320 that could be formed on a surface (e.g., a cardboard box) in accordance with various embodiments of the invention. The latching mechanism 1310 again has the three blades attached to the base. The latching pattern 1320 has three slots cut out which are large enough for the blades to rotate into. Each slot may also have an (engagement) edge, indicated in red in FIG. 13B, that marks the point of the latching pattern 1320 where the blades would contact, specifically when the latching mechanism 1310 is fully engaged/aligned. A photograph of a constructed latching mechanism, having three blades and being fully engaged with a latching pattern, constructed in accordance with some embodiments of the invention is photographed in FIG. 14.

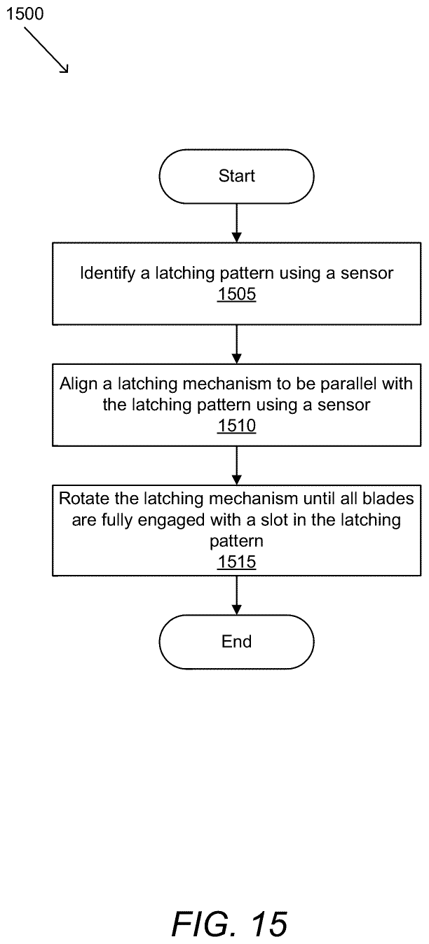

A process for using a latching mechanism to engage with a latching pattern in accordance with several embodiments of the invention is illustrated in FIG. 15. Process 1500 identifies (1505) a latching pattern using a sensor. In accordance with various embodiments of the invention, process 1500 can be performed by robots incorporating (but not limited to) at least one sensor. Incorporated sensors can include (but are not limited to) light sensors, cameras, and/or depth sensors. In some embodiments, a latching pattern is identified by a robot to which a latching mechanism is attached.

Process 1500 aligns (1510) a latching mechanism with the latching pattern using the sensor. In some embodiments, the latching mechanism and latching pattern may or may not be touching when fully aligned. Additionally or alternatively, in many embodiments, the latching mechanism and latching pattern can be aligned within an acceptable bound of misalignment. Such bounds can be measured in terms of (but are not limited to) distance, angle, and/or skew.

Process 1500 rotates (1515) the latching mechanism until each of the blades is fully engaged with a corresponding slot in the latching pattern. In various embodiments, the latching mechanism and latching pattern are magnets that the robot moves together until they are fully engaged. In some embodiments, the latching mechanism is a hook and the latching pattern is a loop that the robot hooks together. In many embodiments, the robot continues to apply torque to the latching mechanism to keep the latching mechanism and latching pattern fully engaged.

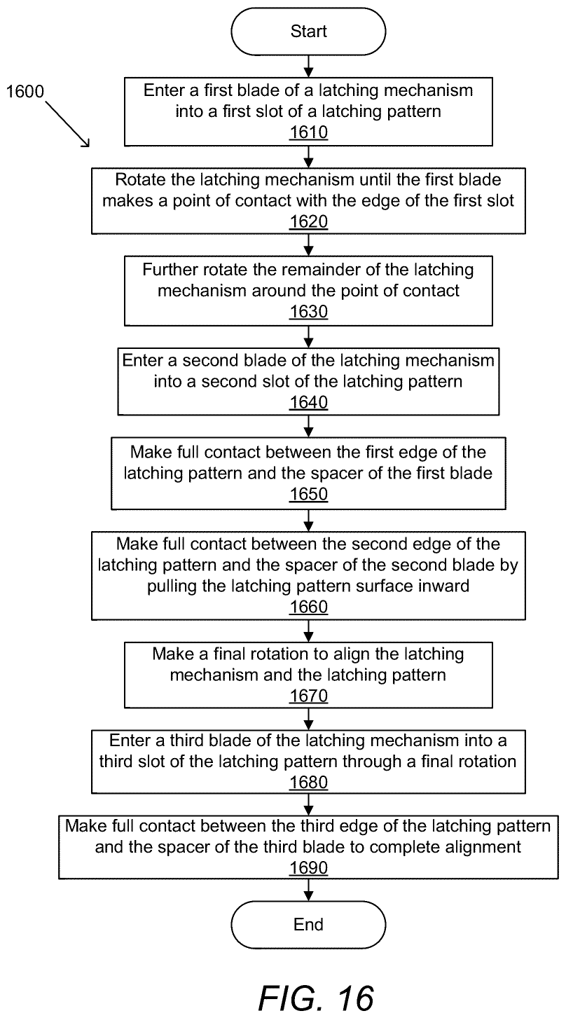

In some situations, the latching mechanisms may be prevented from fully engaging with the latching pattern (e.g., a sudden jolt, a miscalculation, a bent blade). In many embodiments, slots may be angled to increase the likelihood that the latching mechanism(s) and latching pattern(s) can successfully engage, even in cases when they are misaligned. An example of a process for successful engagement of a latching mechanism (following misalignment) that is performed in accordance with multiple embodiments of the invention, is illustrated in FIG. 16. Process 1600 may be performed by a latching mechanism configured, as above, with a plurality of blades. Process 1600 enters (1610) a first blade of a latching mechanism into a first slot of a latching pattern. By way of example, when latching mechanisms approach latching patterns but are misaligned, the misalignment may result in only one of the sloped blades successfully entering the slot. Process 1600 rotates (1620) the latching mechanism until the first blade makes a point of contact with the edge of the first slot. In such cases, the latching mechanism can continue to rotate in one direction (e.g., clockwise) until the sloped blade reaches an edge of one of the (e.g., cardboard) cutouts on the latching pattern. Process 1600 further rotates (1630) the remainder of the latching mechanism around the point of contact. The latching mechanism may rotate until it brings the second blade into contact with the latching pattern (e.g., triangular cutout).

Process 1600 enters (1640) the second blade into a second slot of the latching pattern. Doing so may begin moving the latching pattern surface along the slope of the blade, pulling the latching mechanism closer to the latching pattern surface. Process 1600 makes (1650) full contact between the first edge of the latching pattern and the spacer (at the bottom) of the first blade. In this state, the edge (e.g., of the cutout) may lay flush against the flat face of the spacer. Additionally or alternatively, the edge and the spacer may be held together by the clockwise torque of the assembly.

The latching mechanism can be constrained by the angle of the (e.g., triangular) latching pattern to travel along the contact edge (i.e., moving in the upper right-hand direction). Process 1600 thereby pulls the latching pattern surface inward by sliding the second blade into the second slot of the latching pattern (e.g., triangular) cutout. Process 1600 makes (1660) full contact between the second edge of the second slot and the spacer at the bottom of the second blade through pulling the latching pattern inward. With these two linear constraints, process 1600 enters (1670) the third blade into the latching pattern through a final (e.g., clockwise) rotation to align the latching mechanism and the latching pattern. Process 1600 makes (1680) full contact between the third edge of the latching pattern and the spacer of the third blade. At this point, the alignment process may be considered complete, and the robot attached to the latching pattern surface. In accordance with various embodiments of the invention, the entire procedure described above can occur at a continuous speed without stopping. In some embodiments, the latching mechanism can continue to apply torque to maintain contact with the latching pattern surface.

While specific processes for aligning latching mechanisms and latching patterns are described above with respect to FIGS. 15-16, any of a variety of processes can be utilized to align a latching mechanism and a latching pattern as appropriate to the requirements of specific applications in accordance with some embodiments of the invention. In multiple embodiments, steps may be executed or performed in any order or sequence not limited to the orders and sequences shown and described. In some embodiments, some of the above steps may be executed or performed substantially simultaneously where appropriate or in parallel to reduce latency and processing times. In various embodiments, one or more of the above steps may be omitted.

Further, while specific implementations of latching mechanisms and latching patterns are described above with respect to FIGS. 13-16, there are numerous configurations of latching mechanisms and latching patterns, including, but not limited to, first-touch fasteners such as Velcro, and/or any other configuration that can be utilized as appropriate to the requirements of a given application in accordance with various embodiments of the invention.

### Locking Mechanism

In many embodiments of the invention, end-effectors with latching mechanisms may include but are not limited to locking mechanisms. In certain embodiments, locking mechanisms may extend from the latching mechanisms (e.g., once the latching mechanisms fully connect to the latching pattern surface(s). In some embodiments, the locking mechanisms may be configured to prevent the latching mechanism(s) and the latching pattern surface(s) from disconnecting. Various locking mechanisms, that can be utilized in combination with latching mechanisms configured in accordance with certain embodiments of the invention, are described below.

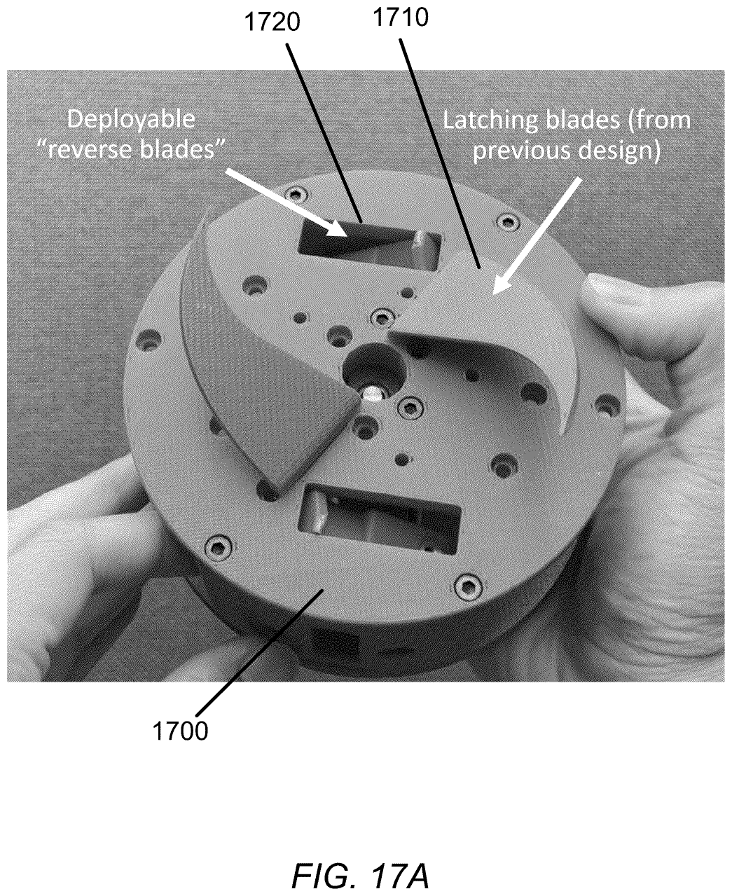

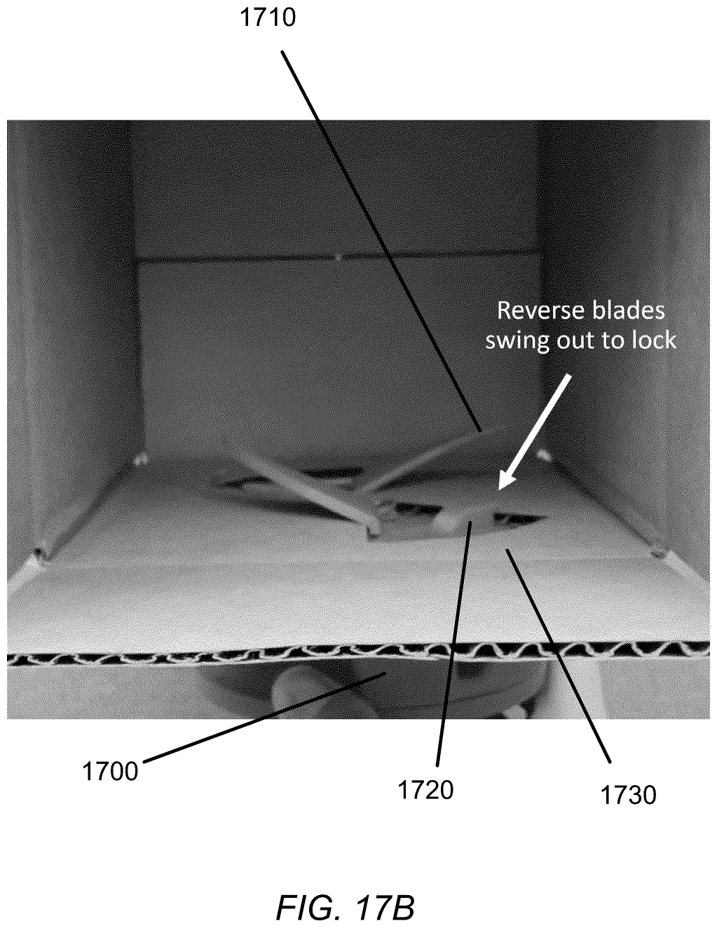

An example of a latching mechanism with a locking mechanism (and the full engagement of the latching mechanism to a latching pattern using a locking mechanism) configured in accordance with multiple embodiments of the invention is shown in FIGS. 17A and 17B. FIG. 17A illustrates a photograph of a latching mechanism 1700 with two blades 1710, and an extendable locking mechanism 1720. In many embodiments, locking mechanisms 1720 may be made up of (but are not limited to blades, pins, and/or magnets). The example disclosed in FIG. 17A further illustrates locking mechanisms 1720 configured in the form of deployable reverse blades. Such blades may be released once the latching mechanism(s), and the latching pattern(s) are in full alignment. Additionally or alternatively, potential locking mechanisms 1720 implemented in accordance with various embodiments of the invention may include but are not limited to deployable locks, (e.g., passive) spring-loaded locks, magnetic locks, and pneumatically actuated locks. Additionally or alternatively, locking mechanisms 1720 may take the form of sets of linear pins that extend from the latching mechanism 1700 into the latching pattern. In various embodiments, the locking mechanism 1720 may include any number of components including but not limited to extendable blades. FIG. 17B illustrates the same latching mechanism 1700 with two blades 1710, where the blades are fully engaged to a latching pattern 1730 with two cutouts. In the scenario disclosed in FIG. 17B, the locking mechanism 1720 connected to the latching mechanism is fully extended.

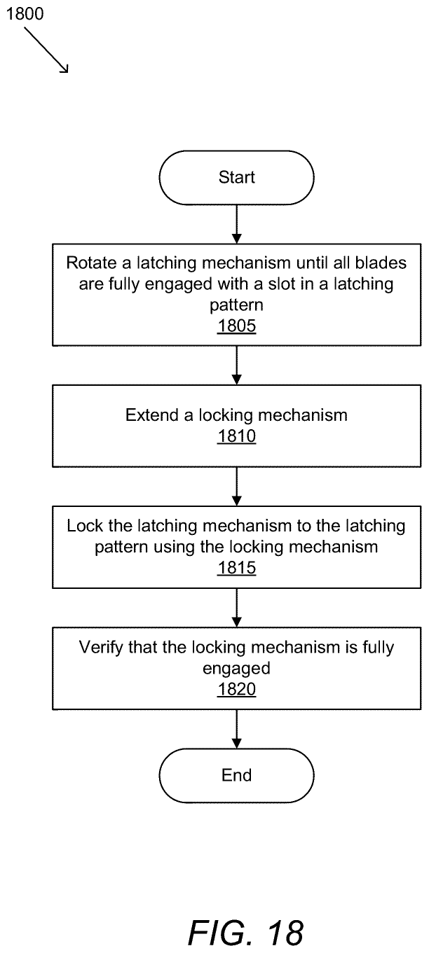

A process for using a latching mechanism to engage with a latching pattern and a locking mechanism to lock the latching mechanism in accordance with an embodiment of the invention is illustrated in FIG. 18. Process 1800 may be performed by (e.g., arm-like) robots in accordance with some embodiments of the invention.

Process 1800 rotates (1805) a latching mechanism until each of the blades of the latching mechanism are fully engaged with a corresponding slot in a latching pattern. Process 1800 extends (1810) a locking mechanism from the latching mechanism. In some embodiments, the locking mechanism may be a set of one or more tabs that extend into one or more slots in the latching pattern. In various embodiments, the locking mechanism can be attached to one or more of the blades of the latching mechanism. Process 1800 locks (1815) the latching mechanism to the latching pattern using the locking mechanism. Process 1800 verifies (1820) that the locking mechanism is fully engaged. In various embodiments, the robot can be configured to verify that the latching mechanism is fully engaged by attempting to disengage the latching mechanism from the latching pattern. In a number of embodiments, the robot can verify that the latching mechanism is fully engaged using a sensor.

While specific implementations of the locking process are described above with respect to FIG. 18, there are numerous configurations of locking mechanisms as appropriate to the requirements of specific applications in accordance with certain embodiments of the invention. In many embodiments, steps may be executed or performed in any order or sequence not limited to the order and sequence shown and described. In numerous embodiments, some of the above steps may be executed or performed substantially simultaneously where appropriate or in parallel to reduce latency and processing times. In various embodiments, one or more of the above steps may be omitted. Although the above embodiments of the invention are described in reference to package deliveries, the techniques disclosed herein may be used in any type of transportation applications.

While specific locking mechanisms and latching mechanisms and processes for latching and locking are described above with respect to FIGS. 17A-18, there are numerous implementations for locking and latching mechanisms that can be utilized in robots including (but not limited to) arm-like robots as appropriate to the requirements of a given application in accordance with various embodiments of the invention.

### Multiple Arm-Like Robot Coordination

In accordance with various embodiments of the invention, two or more arm-like robots can coordinate to manipulate objects. In some embodiments, two arm-like robots can attach to delivery packages, creating a combined robot that has the body of a delivery package and two robotic limbs. In certain embodiments, four arm-like robots can attach to a delivery package, creating a robot that looks similar to a quadruped, with the body of the quadrupedal robot being the delivery package and each of the arm-like robots forming a limb of the quadruped. In many embodiments, one or more of the arm-like robots can be configured to send instructions to the other arm-like robots including but not limited to instructions of what to latch to, unlatch from, and/or how to move. Multiple arm-like robots coordinating in accordance with various embodiments of the invention are described below.

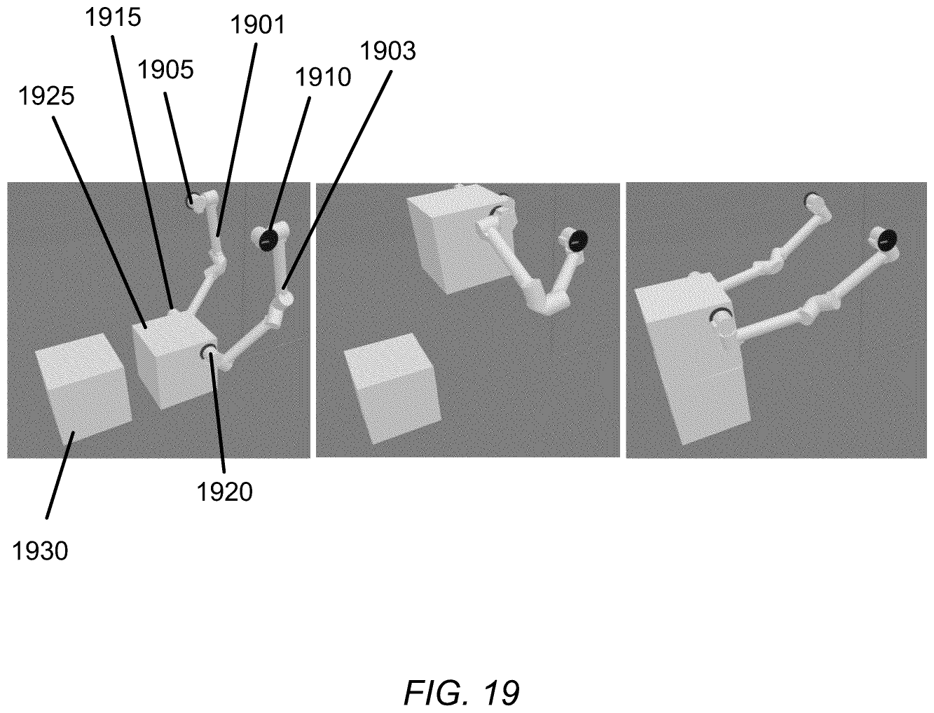

Examples of two arm-like robots coordinating together in accordance with many embodiments of the invention are illustrated in the steps depicted in the three images of FIG. 19. Two arm-like robots 1901, 1903 are latched to anchor points using latching mechanisms 1905, 1910. The ends of the arm-like robots 1901, 1903 that are anchored to the anchor points function as the base of each manipulator. Latching mechanisms 1915, 1920 located at the other end of each of the arm-like robots 1901, 1903 are shown connected to a delivery package 1925. In some embodiments, one or more arm-like robots 1901, 1903 may be connected to delivery package(s) 1925 using latching mechanisms 1915, 1920 that engage with latching patterns formed on the surface of the delivery package. In a number of embodiments, the arm-like robots can (additionally or alternatively) connect to delivery packages using magnets. As described above, arm-like robots configured in accordance with various embodiments of the invention can cooperate to lift delivery packages and place them delivery package on top of other packages. In some embodiments, the two arm-like robots may be delivered instructions to coordinate together to lift and place the boxes. In various embodiments, one of the two arm-like robots can be able to transmit/receive instructions to the other arm-like robot to coordinate motion planning and behavior. In several embodiments, the arm-like robots may be connected wirelessly using (but not limited to) Wi-Fi, Bluetooth, and/or radio. In certain embodiments, the arm-like robots are connected using a wired connection.

According to public statistics, 86% of Amazon's packages are less than 5 Ibs. In some embodiments, arm-like robots may thereby be configured to have lifting capacities of at least 2 kg. In various embodiments, packages of much higher weight can still be handled by a system of multiple arm-like robots working in tandem.

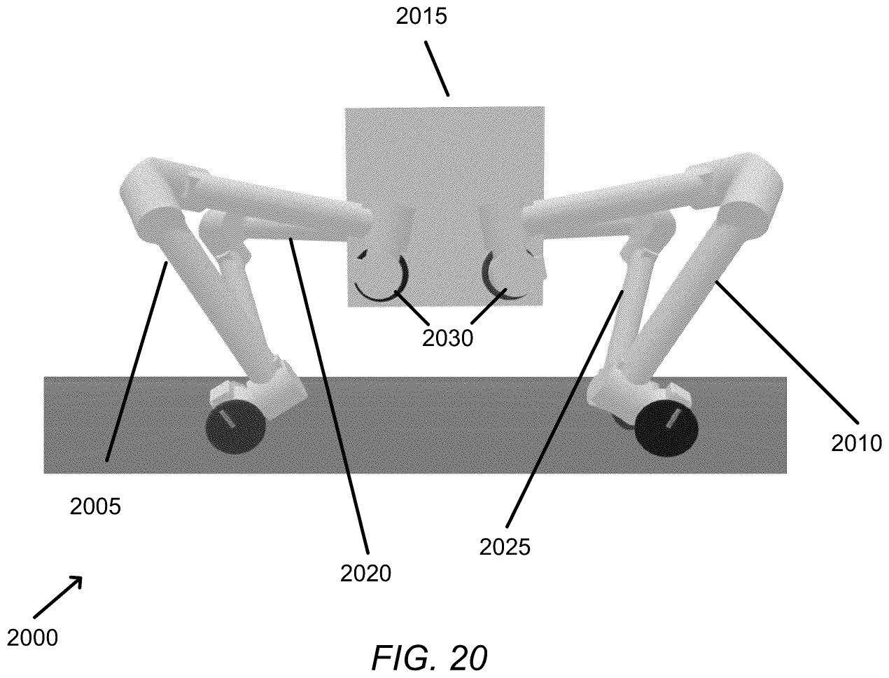

An example of four arm-like robots coordinating together to lift an object in accordance with multiple embodiments of the invention is illustrated in FIG. 20. A quadrupedal robot system 2000 can be formed by four arm-like robots 2005, 2010, 2020, 2025 attaching to objects such as (but not limited to) packages 2015. In accordance with several embodiments, each of the arm-like robots can attach to latching patterns formed in the surface(s) of the delivery package(s) using latching mechanisms 2030. In various embodiments, the arm-like robots 2005, 2010, 2020, 2025 can connect to the packages 2015 using magnets. The arm-like robots 2005, 2010, 2020, 2025 can coordinate motion planning and/or behavior to lift the packages 2015 concurrently. In some embodiments, at least some of the four arm-like robots 2005, 2010, 2020, 2025 may be delivered instructions to coordinate together to lift and move the packages 2015. In multiple embodiments, one of the four arm-like robots (e.g., 2025) may send instructions to one or more of the other arm-like robots (e.g., 2005, 2010, 2020). In some embodiments, the arm-like robots 2005, 2010, 2020, 2025 may be connected wirelessly using (but not limited to) Wi-Fi, Bluetooth, and/or radio. In various embodiments, the arm-like robots may be connected using a wired connection.

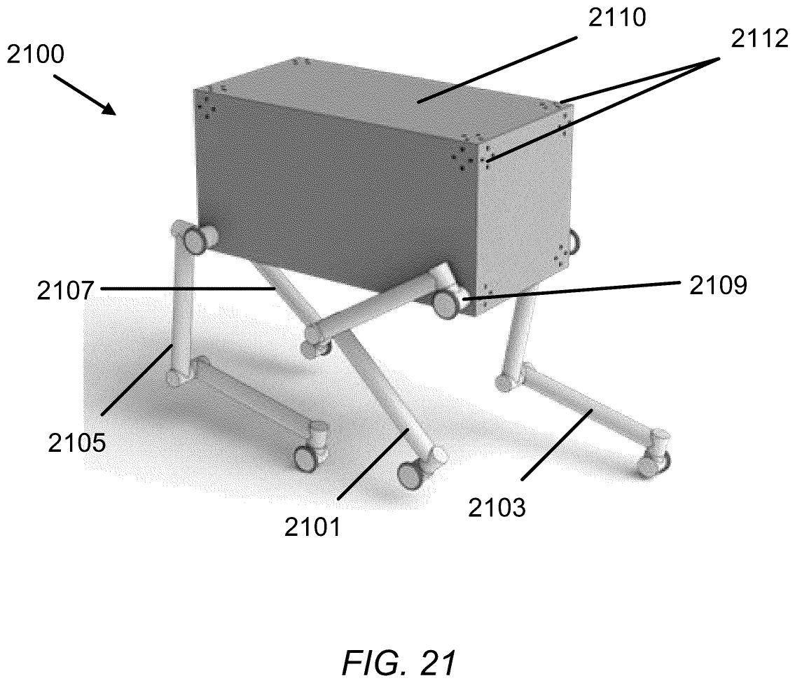

An example of multiple arm-like robots coordinating together to perform a walking motion in accordance with many embodiments of the invention is illustrated in FIG. 21. The (quadrupedal) robotic system 2100 disclosed in FIG. 21 is constructed by four arm-like robots 2101, 2103, 2105, 2107 that are attached to a delivery package 2110. Nevertheless, any combination of two or more robots 2101, 2103, 2105, 2107 may coordinate behavior (e.g., walking) in accordance with many embodiments of the invention. In the illustrated embodiment, latching mechanisms formed on the end-effectors 2109 of each of the arm-like robots attach to latching patterns 2112 formed in the surfaces of delivery packages 2110. By coordinating the motion plans for each of the robots 2101, 2103, 2105, 2107, in accordance with some embodiments of the invention, robotic systems 2100 formed by combinations of (e.g., four) arm-like robots and the delivery packages 2110 can engage in complex behaviors including (but not limited to) quadrupedal walking behaviors. In various embodiments, the arm-like robots 2101, 2103, 2105, 2107 can lower delivery packages 2110 to place them on surfaces and detach from them (e.g., at the same time, subsequently). Additionally or alternatively, in a number of embodiments of the invention, robots 2101, 2103, 2105, 2107 may be configured to detach from packages at different times.

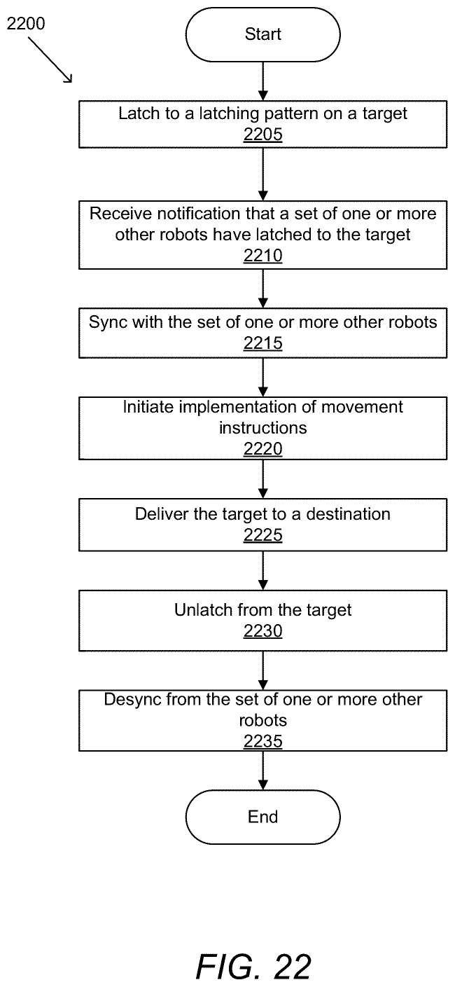

A process for coordinating the motion planning and/or behaviors of multiple arm-like robots to move a target object in accordance with various embodiments of the invention is illustrated in FIG. 22. Process 2200 may be performed by at least one arm-like robot in accordance with some embodiments of the invention. Process 2200 latches (2205) to a latching pattern on a target object (e.g., cardboard delivery package). The robot can wait until a set of one or more other robots have latched to a latching pattern on the target. In some embodiments, a robot can unlatch from one latching pattern and latch to a different latching pattern so that another robot can latch to the initial latching pattern. Process 2200 receives (2210) a notification that a set of one or more other robots have latched to the target.

Process 2200 synchronizes (2215) with the set of one or more other arm-robots. In accordance with multiple embodiments, individual arm-like robots can be configured to synchronize (2215) with some or all of the other arm-like robots that are attempting to coordinate behavior. In various embodiments, the arm-like robots can synchronize through ways including but not limited to synchronizing directly with each other and/or synchronizing with a centralized control system that manages all of the arm-like robots (including arm-like robots that are not directly participating in the coordinated behavior).

At least one of the arm-like robots can be configured to receive movement instructions. In various embodiments, the robot receives movement instructions from one or more of the other arm-like robots in the set of arm-like robots that are coordinating their behavior and/or the centralized control system. In several embodiments, process 2200 initiates (2220) implementation of the movement instructions. In some embodiments, the set of arm-like robots can be configured to coordinate their motion planning to move the target object and process 2200 delivers (2225) the target object to a desired destination.

Once delivered, process 2200 unlatches 2230 from the target object and ceases coordinated behavior. Process 2200 desynchronizes (2235) from the set of arm-like robots. In several embodiments, each arm-like robot in the set of arm-like robots that are cooperating can be configured to desynchronize (2235) simultaneously and/or asynchronously. In some embodiments, the arm-like robot may be configured to return to the location where it latched to the target object and perform actions including but not limited to resuming a previous task and/or receiving a new task. In a number of embodiments, the arm-like robot can adopt a pose suited to performing a particular motion such as (but not limited to) two-wheeled motion. In various embodiments, the arm-like robot can attach to at least one of the arm-like robots to adopt a configuration suited for another form of locomotion.

Once a need for cooperation completes (when a set of arm-like robots are performing a synchronized task including but not limited to delivery of a target object), at least one of the arm-like robots may be configured to desynchronize from the other arm-like robots in the set of arm-like robots. In some embodiments, the desynchronization occurs when a goal is achieved. In various embodiments, the desynchronization occurs when an error has occurred. In some embodiments, the desynchronization can occur with human input. As can readily be appreciated, the initialization of synchronized behavior and the trigger to desynchronize the behavior of a set of arm-like robots is typically dependent upon the requirements of a specific application.

While specific implementations of robotic systems formed by connecting multiple robots and coordinating their motion planning and/or behavior are described above with respect to FIGS. 19A-22, numerous implementations for robots to coordinate together, including, but not limited to, a set of robots sending instructions to each other and/or any other configuration can be utilized as appropriate to the requirements of a given application in accordance with various embodiments of the invention. In many embodiments, steps may be executed or performed in any order or sequence not limited to the order and sequence shown and described. In numerous embodiments, some of the above steps may be executed or performed substantially simultaneously where appropriate or in parallel to reduce latency and processing times. In various embodiments, one or more of the above steps may be omitted. Although the above embodiments of the invention are described in reference to coordination between robots, the techniques disclosed herein may be used in any type of system coordination.

### Systems for Last-Mile Delivery

In various embodiments, last-mile delivery systems that utilize arm-like robots may include various tools and devices including (but not limited to) an autonomous delivery vehicle, a human-operated delivery vehicle, servers, electronic package manifests, human interface devices, and/or networks. In some embodiments, a delivery vehicle may have a communications network that can send instructions to arm-like robots. In many embodiments, a human delivery driver can monitor package delivery and update electronic package manifests. Last-mile delivery systems in accordance with certain embodiments of the invention are described further below.

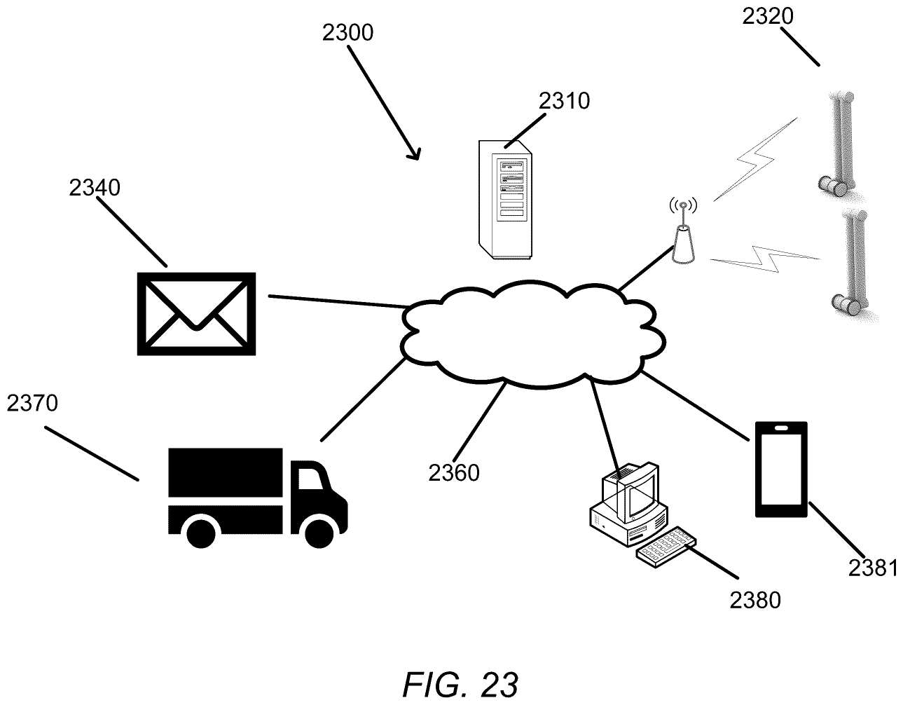

An implementation of a last-mile delivery system network, using modular robotics to transport objects in accordance with several embodiments of the invention is illustrated in FIG. 23. System network 2300 includes a communications network 2360. The communications network 2360 is a network such as the Internet that allows devices connected to the communications network 2360 to communicate with other connected devices. Server system 2310 is connected to the communications network 2360. The server system 2310 is a group of one or more servers communicatively connected to one another via internal networks that execute processes that provide cloud services to users over the communications network 2360. One skilled in the art will recognize that a last-mile delivery system may exclude certain components and/or include other components that are omitted for brevity without departing from this invention.

For purposes of this discussion, cloud services are one or more applications that are executed by one or more server systems to provide data and/or executable applications to devices over a network. The server system 2310 is shown each having three servers in the internal network. However, the server systems 2310 may include any number of servers and any additional number of server systems may be connected to the communications network 2360 to provide cloud services. Last-mile delivery systems that utilizes modular robots to deliver packages in accordance with various embodiments of the invention may utilize processes executing on a single server system and/or a group of server systems communicating over the communications network 2360 in order to coordinate the activity of the overall system.

Users may use personal devices 2380 and/or mobile devices 2381 that connect to the communications network 2360. The personal devices 2380 and/or mobile devices 2381 may be utilized to perform processes that enable robots, such as (but not limited to) arm-like robots, to deliver packages in accordance with various embodiments of the invention. In the illustrated embodiment, the personal devices 2380 are shown as desktop computers that are connected via a conventional “wired” connection to the communications network 2360. However, the personal device 2380 may be a desktop computer, a laptop computer, a smart television, an entertainment gaming console, and/or any other device that connects to the communications network 2360 via a “wired” connection. The mobile device 2381 connects to the communications network 2360 using a wireless connection. A wireless connection is a connection that uses Radio Frequency (RF) signals, Infrared signals, and/or any other form of wireless signaling to connect to the communications network 2360. In the example of this figure, the mobile device 2381 is a mobile telephone. However, mobile device 2381 may be a mobile phone, Personal Digital Assistant (PDA), a tablet, a smartphone, and/or any other type of device that connects to the communications network 2360 via wireless connection without departing from this invention.

In the illustrated embodiment, robots 2320 are shown as connected to the communications network 2360 using a wireless connection. However, the robots can be connected via a conventional “wired” connection to the communications network 2360. A wireless connection is a connection that uses RF signals, Infrared signals, Bluetooth signals, Wi-Fi signals, and/or any other form of wireless signaling to connect to the communications network 2360. The robots 2320 can, additionally or alternatively, connect to each other using wireless and/or “wired” connections.

A delivery vehicle 2370 and mail 2340 are also shown in the figure. Mail can refer to (but is not limited to) letters and/or packages. In accordance with various embodiments, vehicles can refer to (but are not limited to) a delivery truck, a delivery plane, and/or a delivery bike. In some embodiments, vehicles may be autonomous and/or driven by a human.

As can readily be appreciated the specific computing system used to coordinate the delivery of packages is largely dependent upon the requirements of a given application and should not be considered as limited to any specific computing system(s) implementation.

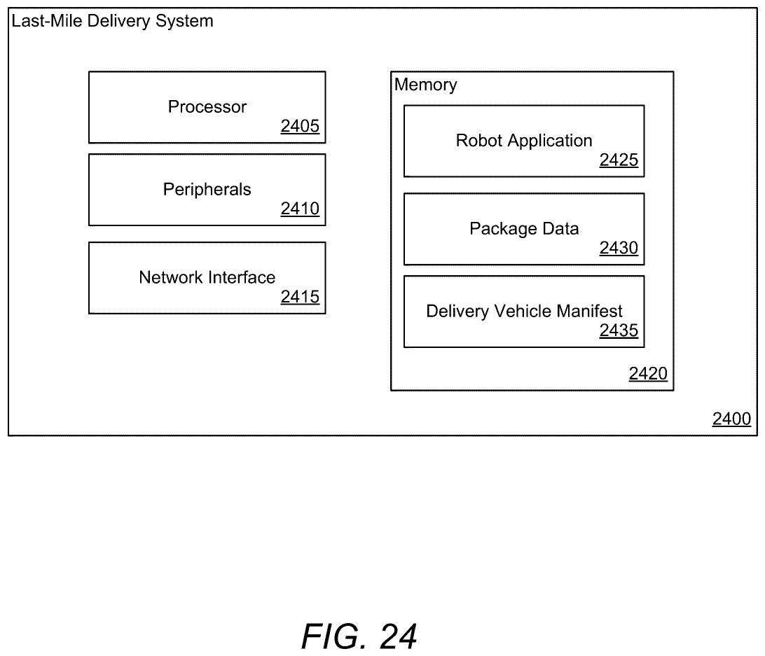

An example of a last-mile delivery server system that executes instructions to perform processes that coordinate the delivery of packages in accordance with an embodiment of the invention is illustrated in FIG. 24. The last-mile delivery server system 2400 includes a processor 2405 system including at least one processor, at least one peripheral 2410, at least one network interface 2415, and memory 2420. One skilled in the art will recognize that the last-mile delivery server system may exclude certain components and/or include other components that are omitted for brevity without departing from this invention.

The processor 2405 system can include (but is not limited to) a processor, microprocessor, controller, and/or a combination of processors, microprocessor, and/or controllers that perform instructions stored in the memory 2420 to manipulate data stored in the memory. Processor instructions can configure the processor 2405 system to perform processes in accordance with certain embodiments of the invention. In various embodiments, processor instructions can be stored on a non-transitory machine-readable medium.

Peripherals 2410 can include any of a variety of components for capturing data, such as (but not limited to) cameras, displays, and/or sensors. In a variety of embodiments, peripherals can be used to gather inputs and/or provide outputs. Last-mile delivery server systems 2400 can utilize the network interface 2415 to transmit and receive data over a network based upon the instructions performed by processor 2405. Peripherals and/or network interfaces in accordance with many embodiments of the invention can be used to gather inputs that can be used to deliver packages.

Memory 2420 can include but is not limited to one or more robot applications 2425 and package data 2430. The robot application(s) can 2425 be used to coordinate and instruct robots using processes similar to those outlined above. In several embodiments, package data 2430 can include various parameters for various packages that can be utilized by processes similar to those described herein. Package data 2430 in accordance with many embodiments of the invention can be updated in response to messages received via the network.

Although specific last-mile delivery server systems are described above with reference to FIG. 24, any of a variety of last-mile delivery server systems can be utilized to perform processes that coordinate the delivery of packages using delivery robots similar to those described herein can be utilized as appropriate to the requirements of specific applications in accordance with various embodiments of the invention.

Although specific methods of last-mile delivery using modular robotics are discussed above, many different methods of last-mile delivery using modular robotics can be implemented in accordance with many different embodiments of the invention. Furthermore, the arm-like robots described herein can be utilized in a variety of applications including (but not limited to) manufacturing, domestic applications, logistics, agriculture, and/or any other application in which movement of objects is required. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An arm-like robot comprising:
a body having two ends, wherein the body comprises a plurality of actuated joints;
a plurality of end-effectors, comprising an end-effector attached at each end of the body, wherein each of the plurality of end-effectors is independently capable of:
anchoring the arm-like robot and forming a load-bearing base; and
connecting to particular objects; and
one or more controllers, wherein the one or more controllers are:
configured to control motion of at least one of the body or the plurality of end-effectors; and
capable, in part using the plurality of actuated joints, of causing:
a first end-effector of the plurality of end-effectors to anchor the arm-like robot and form the load-bearing base; and
a second end-effector of the plurality of end-effectors to latch to a target object.

2. The arm-like robot of claim 1, further comprising:
a first set of one or more motorized wheels attached to a first end of the body; and
a second set of one or more motorized wheels attached to a second end of the body.

3. The arm-like robot of claim 2, wherein the one or more controllers are:
capable of causing the body to adopt a bipedal motion pose in which each set of motorized wheels makes ground contact in a self-balancing manner; and
configured to independently control each motorized wheel, wherein controlling the motion of the body comprises using at least one of the first set or the second set of one or more motorized wheels to move the body in the bipedal motion pose.

4. The arm-like robot of claim 1, wherein the one or more controllers further comprise a communication component, wherein the one or more controllers are:
capable of sending and receiving messages via the communication component; and
configured to coordinate the motion of the body with motion of other robots based at least upon messages received via the communication component.

5. The arm-like robot of claim 4, wherein the communication component coordinates the motion of the body with the motion of the other robots using a wireless connection.

6. The arm-like robot of claim 4, wherein the one or more controllers are configured to use the communication component to:
cause the second end-effector of the plurality of end-effectors to latch to the target object; and
enable three additional robots to latch to the target object with a certain end-effector, creating a combination body.

7. The arm-like robot of claim 6, wherein the one or more controllers are further configured to use the communication component to:
synchronize movement of each part of the combination body; and
cause the combination body to adopt a quadrupedal motion pose in which the first end-effector of the plurality of end-effectors and a second certain end-effector of each of the three additional robots are used to move the combination body in the quadrupedal motion pose.

8. The arm-like robot of claim 6, wherein the one or more controllers is configured to use the communication component to: cause the second end-effector of the plurality of end-effectors and the certain end-effector of each of the three additional robots to desynchronize from the combination body and detach from the target object once the combination body reaches a destination, wherein the destination is determined by messages received via the communication component.

9. The arm-like robot of claim 4, wherein each end-effector of the plurality of end-effectors comprises:
a latching mechanism comprising a plurality of sloped blades; and
a locking mechanism that can be extended from the latching mechanism.

10. The arm-like robot of claim 9, wherein the one or more controllers:
cause the first end-effector of the plurality of end-effectors to anchor the arm-like robot by sliding the plurality of sloped blades of the first end-effector into an anchor point; and
cause the second end-effector of the plurality of end-effectors to latch to the target object by sliding the plurality of sloped blades of the second end-effector into a latching pattern.

11. The arm-like robot of claim 10, wherein:
the anchor point comprises a first plurality of slots on at least one of a floor, a ceiling, or a wall; and
the latching pattern comprises a second plurality of slots on the target object.

12. The arm-like robot of claim 11, wherein:
the anchor point is located in a delivery vehicle; and
the target object is an exterior of a delivery package.

13. The arm-like robot of claim 12, wherein:
the exterior of the delivery package is made out of at least one of cardboard, plastic, or Styrofoam; and
the second plurality of slots comprises a series of cutouts made in the delivery package.

14. The arm-like robot of claim 9, wherein each end-effector of the plurality of end-effectors further comprises at least one spacer configured to constrain the plurality of sloped blades to linear movements as the latching mechanism rotates.

15. The arm-like robot of claim 9, wherein each end-effector of the plurality of end-effectors further comprises at least one sensor wherein the one or more controllers use the at least one sensor to determine whether the locking mechanism is ready to be extended.

16. The arm-like robot of claim 15, wherein a sensor of the at least one sensor is selected from the group consisting of a video camera, a light sensor, a depth sensor, and a proximity sensor.

17. The arm-like robot of claim 9, wherein the plurality of sloped blades are attached to rotatable center islands.

18. The arm-like robot of claim 9, wherein the locking mechanism comprises at least one of a deployable lock, a passive spring-loaded lock, a magnetic lock, and a pneumatically actuated lock.

19. The arm-like robot of claim 1, wherein:
the body comprises one or more elbows; and
the plurality of actuated joints comprises two actuated joints toward each end of the body and two actuated joints near the one or more elbows.

20. The arm-like robot of claim 19, wherein:
each actuated joint of the plurality of actuated joints is moved using at least one of a base motor or an elbow motor; and
each end of the body is attached to a wrist motor capable of rotating an orientation of the end.
